(19) United States
(12) Patent Application Publication
(10) Pub. No.: US 2005/0192851 A1
(43) Pub. Date: Sep. 1, 2005

(54) Methods and systems to purchase bookings

(76) Inventor: Abhay Rangnekar, Mumbai (IN)

Correspondence Address: HELLER EHRMAN LLP, 275 MIDDLEFIELD ROAD, MENLO PARK, CA, 94025-3506, US

(21) Appl. No.: 10/788,522

(22) Filed: Feb. 26, 2004

(51) Int. Cl. G06F 17/60

(52) U.S. Cl. 705/5

(57) ABSTRACT

A method is provided for a customer to enter a booking query at an ATM. Selected booking information is gathered in response to the booking query and then displayed at the ATM interface. A booking is selected from the displayed gathered booking information by the customer at the ATM interface. A confirmation is received of the selected gathered booking information at the ATM interface.

### BACKGROUND OF THE INVENTION

1. Field of the Invention

This invention relates to methods and systems for a customer to purchase a booking, and more particularly to methods and systems for a customer to book travel bookings.

2. Description of the Related Art

The trading of products and services has always involved an interaction of some type between buyers and sellers. Based on the nature of the goods and services this has meant interacting in person or through the various channels of communication making use of postal services, phone, television, email and in recent times the internet. No matter which form of communication selected every sale has two crucial components that can establish a contract between the two parties. One is the transfer of goods or services and the other is the transfer of the consideration for the goods or services. For payment, cash, checks credit cards and money transfer are popular and convenient modes of payment. Depending on the industry and the mode of payment this exchange can take anywhere from a few minutes to many weeks. Different distribution channels have emerged including retail outlets, direct mail, call centers, internet websites, and the like.

However, for the travel industry there has been only one distribution channel and that has been the travel agency. Recently, the internet has emerged as a means of obtaining travel products and services. The industry in particular has some peculiar traits. For one, there is no physical product to deliver. The sale of a service entitles the buyer to enjoy certain privileges for a specific period of time. In the case of an airline reservation it requires the buyer to be present at a predetermined place at an appointed hour to board a flight that promises to transport the occupants to a predetermined destination at a specific time. In the case of a hotel booking, it entitles the customer to use a room at a location for a specific length of time. Both airline seats and hotel rooms are time based perishable commodities that have little value after a certain point in time.

For non-travel related purchases, a customer can buy product that is outdated due to technology, fashion, defects, and the like, at a discount. However, a seat on an airplane that has taken off, or a room for a date in the past, has zero value. In the travel industry there are hundreds of flights and hotels to select from. The quality and range is very much dependent on the person doing the booking. An experienced reliable and caring agent can make a world of a difference.

Currently, all airline bookings are achieved using a third party centralized reservation system (CRS), also referred to as Global Distribution Systems (GDS), such as those offered by Galileo, Amadeus, Worldspan and Sabre. These systems provide an interface between travel agents/websites and the product providers on the other. Each CRS maintains a database that holds inventory of participating vendors including airlines, hotels, cruise companies and car rental agencies. In the case of airlines this includes realtime information on schedules, aircraft, booking classes, booking codes, seat availability, pricing, accompanying rules etc. These GDSs earn revenue from the airlines for every segment sold through their system. Because these systems were developed before the arrival of the internet these are not internet friendly. Hence only trained persons are capable of working on these legacy systems. This apart access is only given to certified travel agencies who can assure viable levels of business.

Travel Agencies do bookings on reservation systems through computer terminals located in their premises. These terminals are connected to a central reservation system either by, a dial-up facility or if the agency is capable of generating substantial sectors per month via a dedicated lease line. Booking inquiries are received either via phone/fax or by personal appearance of the passenger, referred to as a “walk-in client”.

The request is written down and passed on to an experienced and certified reservation staff who are well versed in feeding in passenger requests in a proprietary command driven format. These reservation systems are only allowed to display the listed fares prior to deducting the accredited travel agency's commission. Different airlines can offer additional incentives over and above this commission which is never reflected. Travel agencies are informed of this pricing and the related commissions and incentives for various routes and flights through what are called deal sheets. Once the options available are short-listed, the net fare calculations are made based on the deal sheets received from the corresponding airline. Depending on who the passenger is, mode of payment, past record, nature of relationship, and the like, the passenger is quoted a fare. Thus the fares quoted can sometimes vary from passenger to passenger.

Normally the reservations staff in a traditional travel agency having access to a reservation terminal has to undergo training in the CRS systems proprietary format before he can begin operating the system. The operator has to feed in details to seven queries before a PNR can be generated. Based on the number of passengers and the sectors this booking process can take anywhere from 2/3 minutes to more than an hour.

Fares are calculated based on how much in advance the passenger is doing the booking, the number of passengers, each passenger's age (infant/child/adult/senior citizen), destinations, sectors, flight number, class of travel, duration of travel etc. All passengers desiring to purchase travel bookings have three options. The passengers can either book through travel agents or directly through the vendors themselves or through independent internet based websites such as Expedia, Orbitz, Travelocity, Trips.com, Cheaptickets, Priceline, and the like.

The drawback of doing a booking through travel agents is that they only operate during working hours and may not be able to offer optimum levels of services, transparency and convenience that is possible through the travel websites. Doing bookings directly via the vendor's website/call center can mean restricting choices restricted to fit within the constraints set forth by their service network. With airlines, this can be in the form of needing to accept their hub cities, departure timings, connections and pricing. With hotel bookings, one has to accept its locations, service offerings, choice of rooms and grade. In order to receive the best options requires making multiple phone calls or visiting the websites of a number of service providers. In this context the third option of visiting independent websites offers maximum advantages in that the customer can get to view varied permutations and combinations in a transparent manner so as to make a booking/purchase from anywhere at anytime of the day.

In recent years the internet has emerged as an alternative. Increasingly customers are observing that they can find less expensive fares through the internet than those offered by their travel suppliers. The combination of a downturned economy, rising airline losses, reduced corporate travel, and disappearing agency commissions have hastened a shake-out and made the industry more competitive.

In an effort to bring down the costs, airlines have encouraged the use of electronic tickets (“e-tickets”). An e-ticket is a paperless electronic document used for ticketing passengers, particularly in the commercial airline industry. Virtually all major airlines now use this method of ticketing.

When a customer books a flight by telephone or through the internet, the details of the reservation are stored in a computer. The customer can request that a hardcopy confirmation be sent by postal mail, but it is not needed at the check-in desk. A confirmation number is assigned to the passenger, along with the flight number(s), date(s), departure location(s), and destination location(s). When checking in at the airport, the passenger simply presents proof of identification, boarding passes are issued, and the passenger can check luggage and proceed through security to the gate area.

One major advantage of e-ticketing is the fact that it reduces booking expense by eliminating the need for printing and mailing paper documents. Another advantage is eliminating the possibility of critical documents getting lost in the mail or being sent to the wrong address.

However, accessing the internet is not suitable for everyone. Except for the younger generation, adoption rates for others is still low. Coupled to that are the fears and doubts associated with internet security. Buying through the internet requires the customer to possess a valid debit/credit and then to part with the card details. Although data encryption is safe it is something that many find risky.

In U.S. Patent Application Publication No. 20010016825, a booking is made through an airline, which then mails to the customer a special ID card. The customer utilizes the ID card at a special airline ATM. The special airline ATM is used by the customer, with the special ID card, for electronic authorization and validation of airline reservations, and is also used to eliminate paper tickets. Each airline has its own network of ATMs customer ID cards which cannot be used on each others ATM's.

Current methods of doing bookings have numerous limitations. For example with travel, finding the desired flight at the best prices is largely governed by the channel of distribution selected from the customer. Each channel offers varied choices with an inherent bias that is dependent on who is offering the service. If it's the travel agency then it is reachable only during office hours on weekdays and there is little transparency. If it is the airline directly then you have limited choice. If it's the internet website you have problems of connectivity and security. Cancellations and refunds can be tedious and may require days depending on mode of payment. When a booking receipt or the transaction details are lost it is difficult to receive a duplicate set without going through identification procedures. Communicating with the agency/airline or the website travel desk can often mean waiting for long periods of time while going through the voice response systems and call center operators who are invariably busy and you are put on hold. Changes or cancellations in itineraries brings uncertainties about the cancellation charges and the amount eligible for refund.

Governments in approximately 80 countries have authorized lottery games. These include lottery, numbers, and keno, as well as instant “scratch-off” ticket games. These lotteries are primarily set up as a means of generating non-tax revenues. In the United States, lottery revenues are frequently designated for particular purposes, such as for education, economic development, conservation, transportation and aid to the elderly. There are currently 38 states and the District of Columbia operating lotteries in the United States, with aggregate annual lottery sales in excess of US $40 billion. Worldwide lottery sales, excluding the US, exceed $90 billion per year.

Today, there are two basic types of lotteries (games), instant and online. Instant games enable the player to scratch off a masked area on a ticket to reveal the game result and prize. Online lotteries allow participants to select a number that will be a winner if all or part of it matches numbers selected in a scheduled drawing. Online lotteries are, by far, the most popular, accounting for nearly 75 percent of worldwide lottery revenue.

Recently, with the innovation of faster online games and more convenient venues, the distinction between the two categories has blurred, and other forms of lottery are emerging. For example, video lotteries are also demonstrating their popularity, particularly among younger players who are drawn to this technology and style of play.

Lottery players have a broader range of choices, with more different styles, frequencies and payoffs than ever before, and include those listed as follows:

Lotto—This is the most popular online lottery game. Players select a set of numbers from a pool of choices (6 from 49, 5 from 30, 6 from 52 and 3 from 49 are the most popular variations). More than $10 billion in revenue comes from U.S. lottery sales of this type.

Multi-State Games—A multi-state game is a game where several states offer the same game with the same parameters and share the same draw. The most popular multi-state games are large jackpot lottery-style games such as Powerball and the Big Game, and also include big payoff instant scratch tickets. PowerBall is a registered trademark of Multi-State Lottery Association. This game, played in 22 US states, attracts more money and offers larger prizes than any other lottery-style game. The big game is offered in seven states. This lottery-style game recently generated the largest jackpot ever won in American lottery history, a record $395 million.

Numbers—Players typically select a three or four-digit number, although two and five-number variations also are gaining ground. The largest payoffs are given to players who select numbers in the exact order they are drawn. Another choice is to select the numbers drawn, but in any order. The numbers are typically drawn on a daily basis.

Keno—This is offered in nine states is often found in restaurants and taverns. It offers prizes for correctly selecting up to 12 of 20 numbers drawn from a pool of 80. The unique twist is that these drawings take place as frequently as every five minutes.

An on-line lottery system consists of terminals located in numerous retail outlets, a telecommunications network, a central computer system, and communications equipment software. Games typically include lotto, sports pools, daily numbers, cash games, other matrix games, and keno. The lottery terminals are usually located in high-traffic retail locations/outlets such as newsstands, convenience stores, gas stations, food stores, tobacco shops, and liquor stores. The retailer or clerk enters the data or desired transaction on the lottery computer terminal. The wager information is then transmitted via communication lines to the central computer system where the information is verified, recorded, and stored. Winners are able to claim their prizes within minutes of the drawing for the game selected.

The number one criterion of all lottery games is the jackpot, a prize that can accumulate from one game to another if no one wins, potentially reaching hundreds of millions of dollars. Neither the retailer nor the company managing the lottery is responsible for lost or stolen tickets. The player should sign the back of the ticket in ink and take appropriate measures to safeguard it. Lottery tickets are bearer documents. Unless signed, anyone in possession of the ticket can file a claim. Lottery tickets cannot be sold over the internet and federal law prohibits the mailing of lottery tickets.

Currently each state prints its own set of lottery forms which allow players to specify their selections. If a retailer desires to offer lotteries of different states a wide variety of forms will need to be stocked. The machines on which player's selections are scanned and the tickets are generated are not designed to offer or handle a wide selection of state lotteries.

Rules regarding cancellation differ from state to state. In some instances, tickets can be canceled by the originating lottery retailer within a certain period following the transaction. Lottery tickets can not be canceled after a game closes for a drawing, after a drawing occurs, or after the end of the gaming system business day (whichever comes first). Players are responsible for checking their tickets for accuracy. Most lottery tickets are usually valid for six months only. Usually lotteries are restricted to participants of 18 years or older, while some put the limit at 21.

Many state laws require that a lottery organizer provide a winner's name, city of residence, game won, date won and amount won to any third party requesting the information. However, the law may prohibit the lottery organizer from providing certain personal information, such as home address and telephone number. Often a winner cannot remain anonymous, with the winner's personal information becoming public. The lottery winner decides on whether or not the lottery organizer can use photographs, recordings and/or videotape for publicity purposes.

There are numerous disadvantages with current gaming practices. There is no way of identifying or locating the winner unless the individual with the winning combination provides the winning receipt. The onus of checking for the winning combinations rests on the customer. This usually expires in six months but in some states can last up to a year. There are currently limitations on playing lotteries, including the ability to only play in the state of residence. The lottery receipt is the most important document in the whole transaction. If it is not signed and is misplaced or lost the bearer is entitled to the rewards in case of a winning selection. Regular players that prefer to play the same combination numbers again and again must specify their selections on new entry forms for each draw. Playing desired numbers in advance over subsequent draws is not possible. Retrieving details of one's past plays is not possible.

### SUMMARY OF THE INVENTION

Accordingly, an object of the present invention is to provide booking methods and systems that provide customers to do bookings through ATM's.

Another object of the present invention is to provide booking methods and systems that permit customers to access and purchase services in real time and in a transparent manner.

Yet another object of the present invention is to provide booking methods and systems that utilizes the existing network of installed ATMs with minimal modifications or alterations.

A further object of the present invention is to provide booking methods and systems that allows product providers and customers to interact in a secure environment, where all processes from initial need to display of choices to customer selection to sale to establishing a contractual obligation are handled in sequence with a printed proof of the transaction.

Another object of the present invention is to provide booking methods and systems that allow real time settlement of transactions by transferring money from the buyer to the seller in the case of a purchase and vice versa in case of a cancellation, and without ambiguity and misunderstanding.

A further object of the present invention is to provide booking methods and systems that makes it convenient for the customer to make purchases at any time of the day in a familiar environment without any need to acquire new skills.

Yet another object of the present invention is to provide booking methods and systems that automatically keep a record of all transactions, and allows customers to retrieve records of previous purchases and print additional copies in case of lost or misplaced receipts eliminating all worries.

These and other objects of the present invention are achieved in a method of booking. At least one booking query is entered at an ATM interface by a customer. Selected booking information is gathered in response to the booking query and then displayed at the ATM interface. A booking is selected from the displayed gathered booking information by the customer at the ATM interface. A confirmation is received of the selected gathered booking information at the ATM interface.

In another embodiment of the present invention, a system is provided for bookings and includes an ATM interface. A host system is coupled to the ATM interface. A product provider system is coupled to the host system. In response to a booking query received by the host system from a customer, the host system queries the product provider system, and the product provider system provides responses to the host system relative to the queries. A financial service system is coupled to the host system.

In another embodiment of the present invention, a method for booking a purchase of a product or service through an ATM includes the step of entering at least one booking query at an ATM interface by a customer. A gathering of selected booking information is implemented in response to the booking query. Selection of a booking is implemented from the displayed gathered booking information by the customer at the ATM interface. Receipt of a confirmation of selected gathered booking information is implemented at the ATM interface.

In another embodiment of the present invention, an ATM device is provided for booking a purchase of a product or service through an ATM and includes a display. An ATM interface is coupled to the display. Function display keys are coupled to the ATM interface. A computer program is included that, implements a gathering of selected booking information in response to the booking query by a customer, implements selection of a booking from the displayed gathered booking information by the customer at the ATM interface, and implements receipt of a confirmation of selected gathered booking information at the ATM interface.

In another embodiment of the present invention, a computer readable medium is provided which has stored thereon instructions which, when executed by a processor, cause the processor to perform, executing a first application including gathering selected booking information in response to the booking query and displaying gathered booking information at an ATM interface, executing a second application including selecting a booking from the displayed gathered booking information by the customer at the ATM interface, and executing a third application including receiving a confirmation of selected gathered booking information at the ATM interface.

In another embodiment of the present invention, a computer based system is provided that implements bookings in response to a booking query made at an ATM interface by a customer. A first processor produces selected booking information in response to the booking query made by a customer at an ATM. A second processor selects a booking from the displayed gathered booking information by the customer at the ATM interface. A confirmation of selected gathered booking information is received at the ATM interface.

### BRIEF DESCRIPTION OF THE FIGURES

FIG. 1 is a flow chart that illustrates one embodiment of the methods and systems of the present invention.

FIG. 2 is a schematic diagram illustrating one embodiment of a system of the present invention.

FIG. 3 illustrates one embodiment of an ATM that can be utilized with the FIG. 2 embodiment.

FIG. 4 is a schematic diagram illustrating the relationship between the ATM, financial services system, host system and product provider system of the present invention.

FIG. 5(a) illustrates one embodiment of the present invention with the ATM connecting to a bank server with a host virtual directory.

FIG. 5(b) illustrates one embodiment of the present invention of the present invention with the ATM connects to a special web server.

FIG. 6 is a flowchart for account holders doing bookings through ATM's of the present invention.

FIG. 7 is a flow chart that illustrates an architecture for registering customers for services with the present invention.

FIG. 8 is a flow chart that illustrates an architecture for customers accessing services with different banks with the present invention.

FIG. 9 illustrates one embodiment of an ATM interface that can be utilized with the present invention showing where a new user clicks.

FIG. 10 illustrates one embodiment of an ATM interface with the FDK's and a display showing certain information about a customer.

FIG. 11 illustrates one embodiment of an ATM interface with the FDK's and a display showing customer name and ID number.

FIG. 12 illustrates one embodiment of an ATM interface with an edit profile, airline booking, and retrieve/cancel booking.

FIG. 13(a) is a flow chart illustrating NCR FDK logic.

FIG. 13(b) is a flow chart illustrating DIEBOLD FDK logic.

FIG. 14 is a schematic diagram illustrating one embodiment of the present invention with a plurality of banks coupled to the host system.

FIG. 15(a) is a flow chart illustrating airline availability.

FIG. 16 illustrates one embodiment of an ATM interface with the FDK's and a display showing departure cities.

FIG. 17 illustrates one embodiment of an ATM interface with the FDK's and a display showing destination cities.

FIG. 18 illustrates one embodiment of an ATM interface with the FDK's and a display showing class of travel, journey and departure information.

FIG. 19 illustrates one embodiment of an ATM interface with the FDK's and a display showing certain customer information and an edit function.

FIG. 20 illustrates one embodiment of an ATM interface with the FDK's and a display showing a message relative to direct flights or a flight with segments.

FIG. 21 illustrates one embodiment of an ATM interface with the FDK's and a display showing an example of travel for Bangalore-Delhi and class of travel.

FIG. 22 illustrates one embodiment of an ATM interface with the FDK's and a display showing options for travel between Bangalore-Delhi.

FIG. 23 illustrates one embodiment of an ATM interface with the FDK's and a display showing a message to wait while seats are being booked.

FIG. 24 illustrates one embodiment of an ATM interface with the FDK's and a display showing a message to wait while an itinerary is printed.

FIG. 25 illustrates one embodiment of an ATM interface with the FDK's and a display showing an itinerary.

FIG. 26 illustrates one embodiment of an ATM interface with the FDK's and a display showing a message to enter a reference number for an itinerary.

FIG. 27 illustrates one embodiment of an ATM interface with the FDK's and a display showing an itinerary, with the option to print an itinerary or cancel the itinerary.

FIG. 28 illustrates one embodiment of an ATM interface with the FDK's and a display showing an itinerary, with a message asking the customer if he wants to cancel the itinerary.

FIG. 29 illustrates one embodiment of an ATM interface with the FDK's and a display showing a message that the itinerary is cancelled.

FIG. 30 illustrates one embodiment of a printed receipt.

FIG. 31 is a flow chart illustrating one embodiment of booking attributes and booking availability.

FIG. 32 is a continuation of the FIG. 31 flow chart.

FIG. 33 is a flow chart illustrating one embodiment of cancellations through an ATM of the present invention.

FIG. 34 is a flow chart illustrating one embodiment of cancellations through a phone or internet of the present invention.

FIG. 35 is a flow chart illustrating XML-CLR connectivity that can be used with the present invention.

### DESCRIPTION OF THE PREFERRED EMBODIMENTS

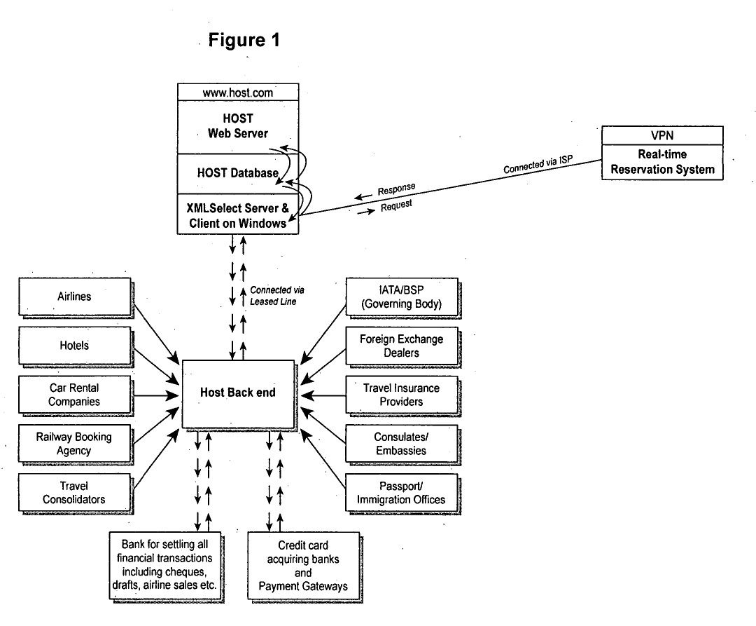

As illustrated generally in FIG. 1, in various embodiments, the present invention provides systems, computer readable medium and methods for bookings. The booking can be a variety of different bookings for the purchase of a service or product, including but not limited to, travel arrangements, airline tickets, purchase and/or sale of stocks and other equities, purchase and sale of fixed deposit investments, gaming, musical events, sporting events, theatrical productions, media subscriptions for television, cable, internet access, mobile, and the like. The methods and systems of the present invention can be utilized for any purchase that can be database driven, and preferably does not include the delivery of a product that can be judged/valued on the basis of it's physical attributes.

With the methods and systems of the present invention, the receipt and transaction for the purchase can establish a contract between a customer and the vendor offering the product or service. The vendor can be a variety of different type of vendors including but not limited to, airline, hotels, car rental companies, stock exchanges, investment entities such as banks, credit unions, mutual funds, gaming companies, state lotteries, media companies, theatres, cinema halls, sports organizers and the like.

With the methods and systems of the present invention, customers can transact a booking in real time by deducting the purchase value from their respective accounts in a secure environment. By way of illustration, when the booking is done through an ATM, the ATM built-in printer can print details that provide evidence of purchase and establish a contract between the customer and the product/service provider. This permits both the customer as well as the product/service provider to track transaction details. Settlement can be through normal banking channels. When there is a cancellation, the transaction can reversed in real time.

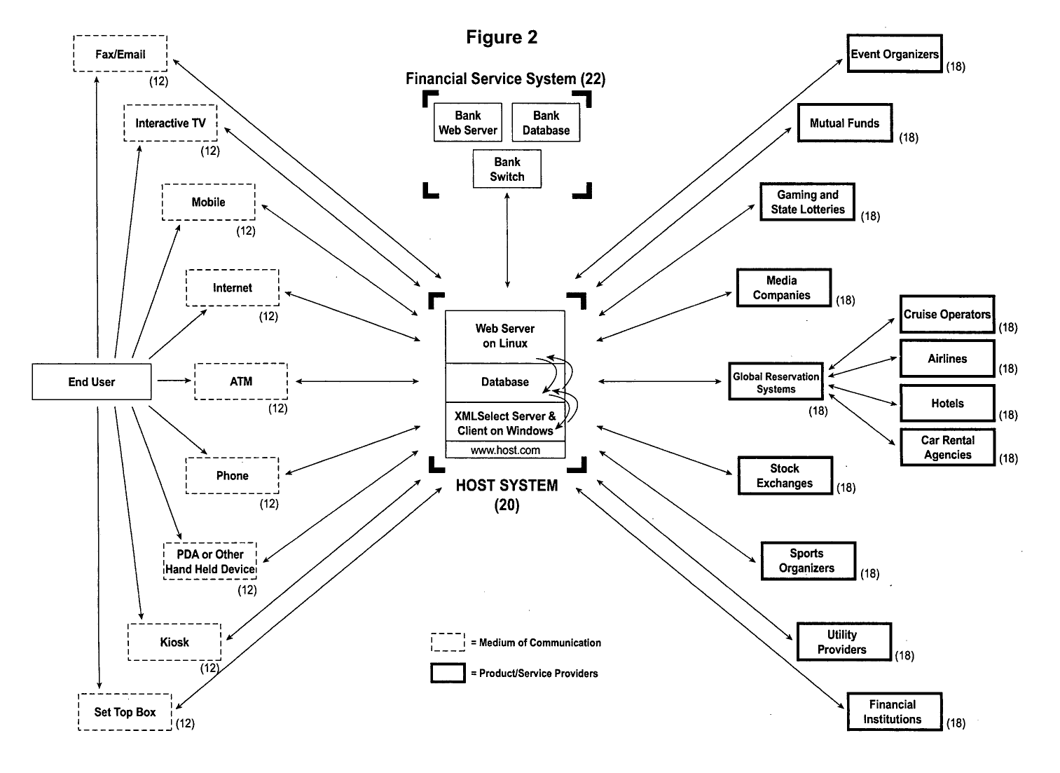

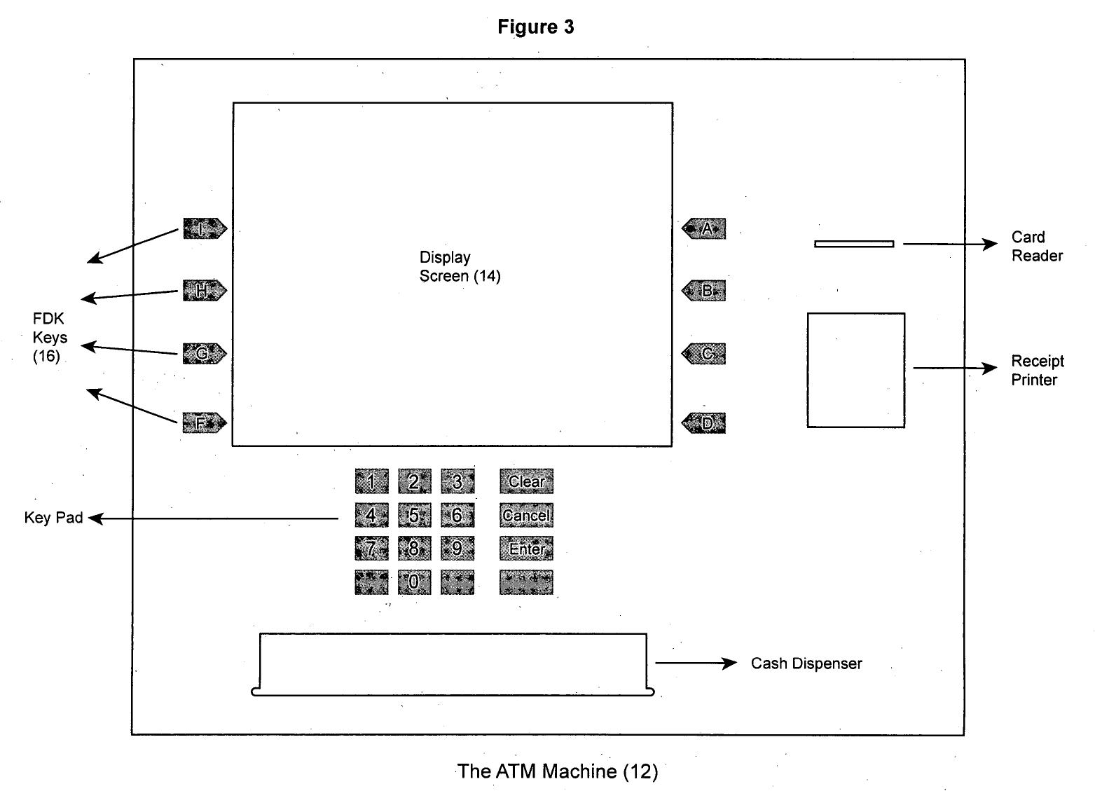

Referring to FIGS. 2 and 3, one embodiment of a system 10 of the present invention includes an ATM 12 with a display 14 and a plurality of function display keys (FDK) 16. A product provider system 18 is coupled to ATM interface 12. A host system 20 is coupled to product provider system 18. A financial service system 22 is coupled to host system 20.

Product provider system 18 provides a number of functions, including but not limited to, travel purchases including but not limited to, airline bookings, hotel bookings, rental car bookings, lotteries/gaming, and the like. Customers are provided choices to either make new air, hotel or car rental bookings or modify and cancel existing ones. Host system 20 provides real time access to an inventory of various airlines, hotels and car rental agencies from product provider system 18. Purchases can be debited to customers accounts or to credit cards. Refunds, in case of cancellations, can be credited back to the source from where initial payment was made.

For the purchase of a lottery or gaming item, such as the lotto, customers are provided with choices to buy new lotteries by specifying their number selections for specific draws or view their selections from previous draws. Purchases can be debited to the customers account.

The methods and systems of the present invention are enable customer to purchase or sell stocks or other equities. Customers can be provided with options to buy stocks in realtime by connecting with stock exchanges. Purchases can be debited to customers account. Sales are credited back to the source from where initial payment was made. For the sale of investments in fixed deposits and mutual funds, transactions can be debited to customers account. Sales are credited back to the source of the initial payment.

Financial service system 22 is utilized for financial settlement purposes of the transaction for the booking.

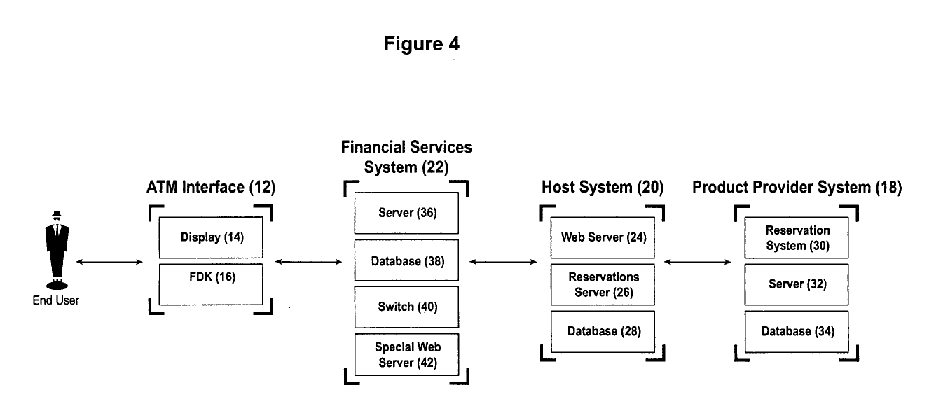

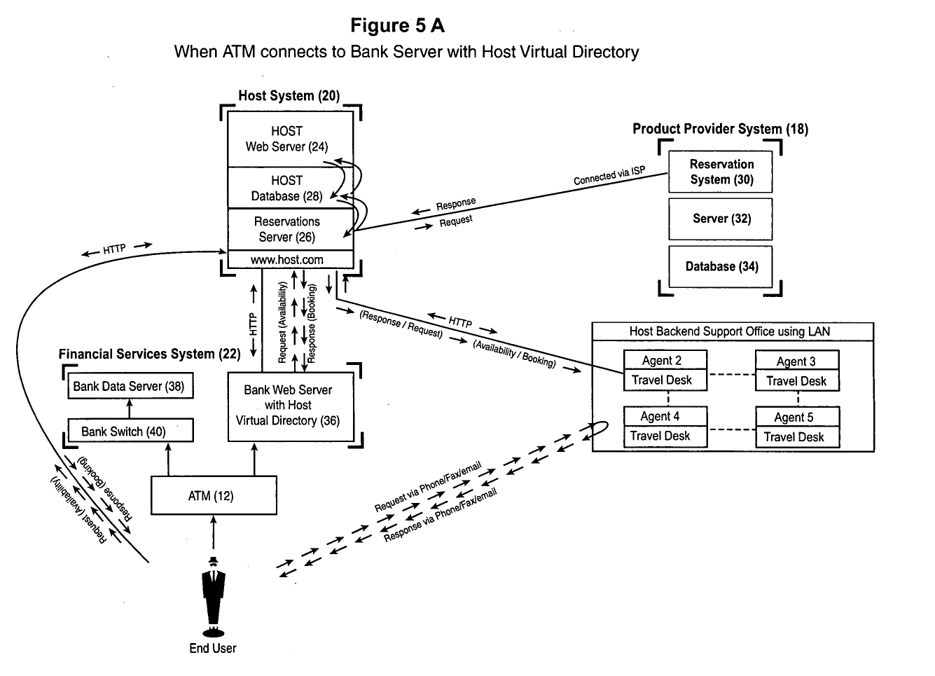

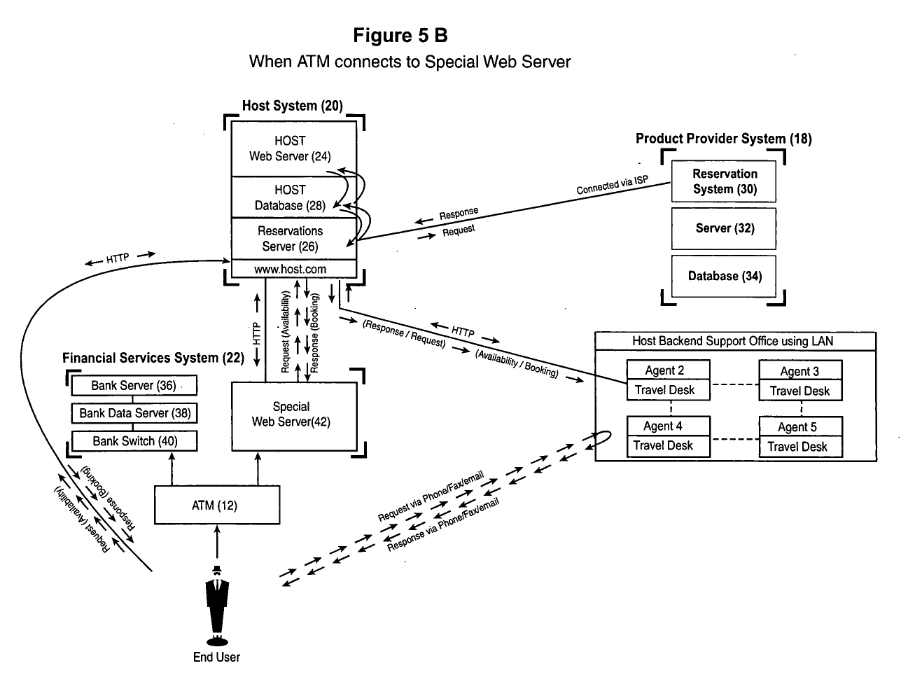

As illustrated in FIG. 4, FIGS. 5a and 5b, host system 20 has an architecture that includes a host system web server 24, a host system reservations server 26 and a host system database 28. System 10 can utilize COM architecture, DCOM, J2EE (Java based) architecture, and the like, to route requests to an external live real time centralized reservation system 30 (“CRS”) that is included in product provider system 18. CRS 30 can be referred to as GDS global distribution system (“GDS”). Examples of GDS' include but are not limited to those operated by Apollo Galileo, Sabre, Worldspan, Amadeus, and the like. Product provider system 22 includes one or more servers 32, and one or more databases 34. Financial service system 22 includes one or more servers 36 and one or more databases 38.

Product provider system database 34 can include at least one of, listings of airline boarding cities, airline destination cities, airlines, flight numbers, times of airline departures, airline fares, and the like. Host system database 28 can include received customer information and access codes to product provider system database 34. In response to a booking query received by host system 20 from a customer, host system 20 queries product provider system 18. Product provider system 18 provides responses to host system 20 in response to the queries. Host system 20 and product provider system 18 can communication several times in response to a booking query received by the host system from a customer.

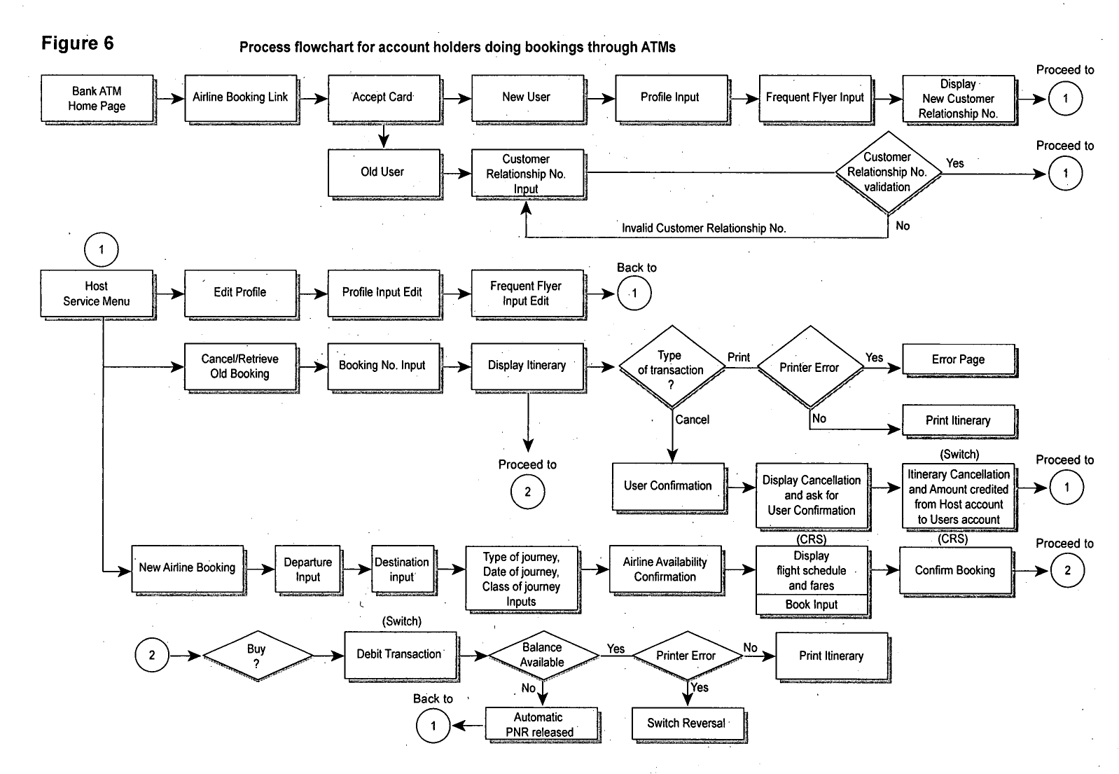

In one embodiment, shown in FIG. 6, host system 20 receives a query from the customer for an airline booking. Host system checks with product provider system 18 for a general list of flights operated by different carriers between the specified cities on the specified dates. Product provider system 18 responds with a list of carriers and their accompanying flight numbers. Host system 20 addresses flight specific queries for each flight number to check the route of the flight, number of sectors, via cities, classes of seats offered, status of specific class codes for each class, the types of aircraft, meals served, and the like. Host system 20 then adds fares wherever applicable according to the class codes, creates viable options, and sorts the data. The sorting can occurs in a variety of different manners including but not limited to on the basis of, departure time, journey time, total fare, arrival time at the destination, least number of sectors first, and the like. Host system 20 then displays the sorted data at display 14 of ATM 12.

When the customer makes a selection, host system 22 sends a request for seats needed on the specified flight(s) to product provider system 18. While sending a request for seats, more data regarding each passenger's name, age, sex, meal request, frequent flier info, contact numbers can also be added. Product provider system 18 responds by generating a PNR.

Customers register with host system 20. Host system 20 gathers the selected booking information. Host system 20 directs the gathered booking to ATM interface 12 where it is displayed. The customer completes a customer profile that is submitted to host system 20.

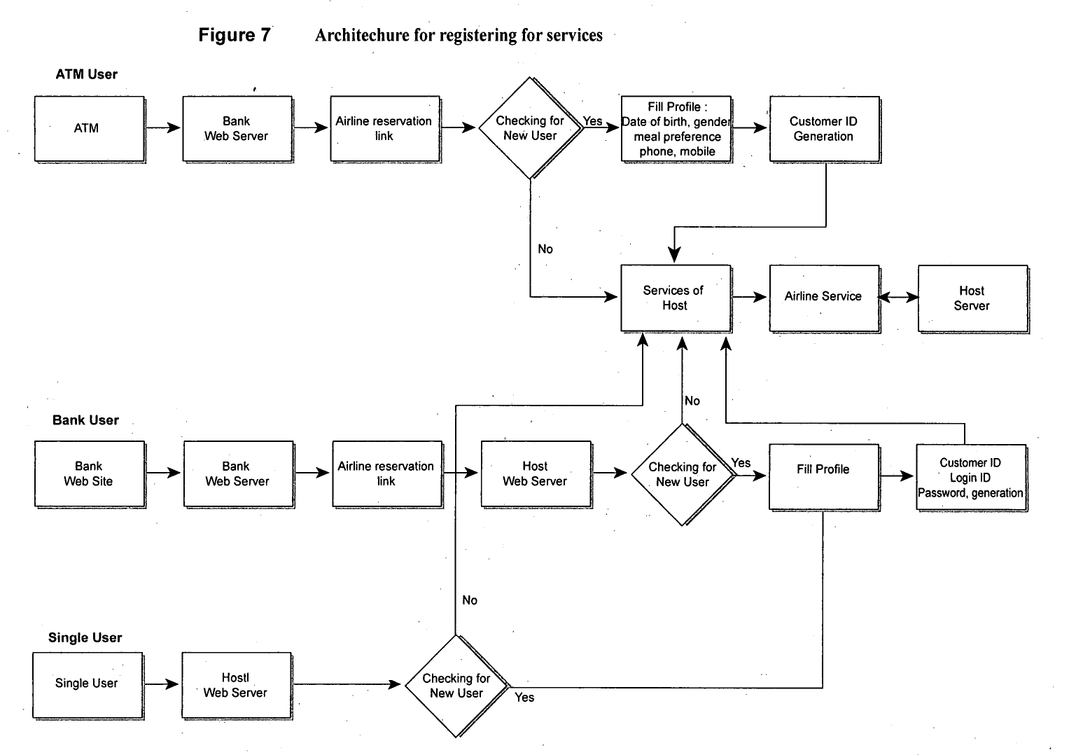

As shown in FIG. 7, in one embodiment of the present invention, a customer inserts an ATM card in an ATM 12 and then clicks on the link of a selected booking, which can be an airline booking. The customer's ATM card number and his name on the ATM card are verified on server 36 of financial service system 22, to determine if the customer is already registered with host system 20. If the customer is registered he is asked to enter his customer relationship number (“CRN”) that has been provided to the customer by host system 20.

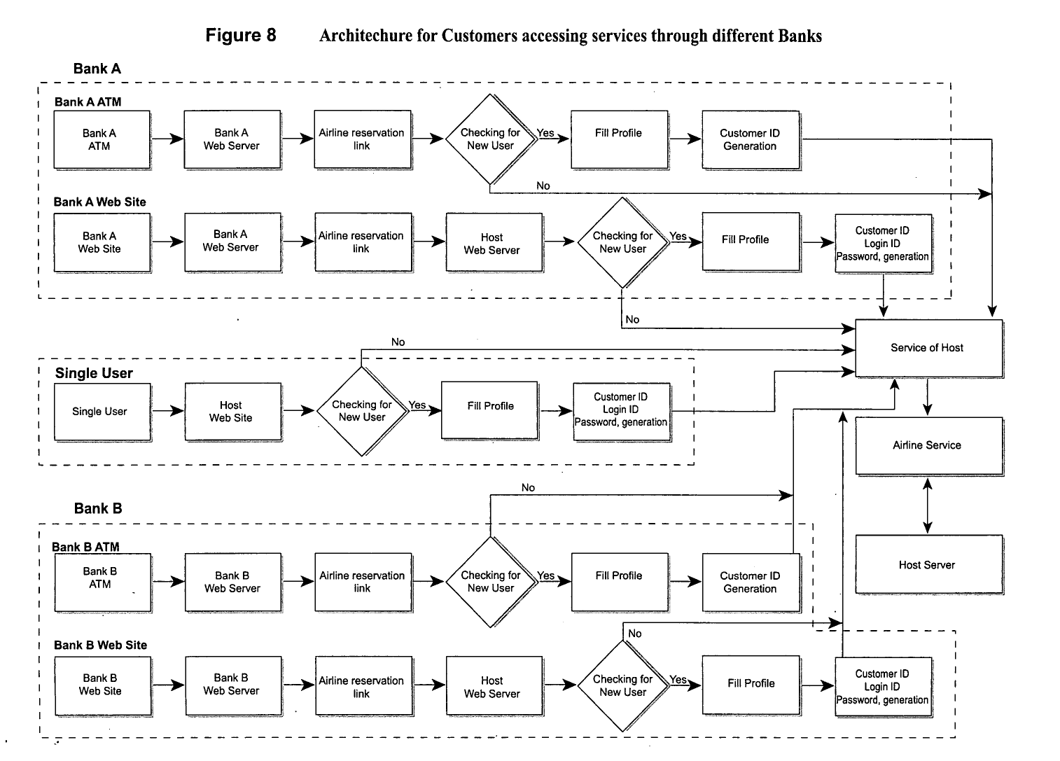

Referring to FIG. 8, if the customer is not registered with host system 20, then there are two options. In the first, the customer is not registered in host system 20 using the ATM card he has used at ATM 12. However, in this embodiment, the customer has registered with host system 20 using another ATM card operated by another bank. The customer may have accounts with a number of different banks each of which may offer travel services dispensed by host system 20 through their ATMs. The methods and systems of the present invention provide that the customer does not have to register again and again. The CRN provided by host system 20 helps link both cards to the same customer, and the customer can access his account by using any ATM card. Host system 20 can also keep track of the customer using different ATM cards as long as he maintains a single CRN.

The second is that the customer is requested to sign-in as a new customer of host system 20, after which he receives his CRN from host system 20 to use host system 20 from ATM's 12, and/or other communication devices including but not limited to the internet, c-mail, fax, mobile device, PDA, kiosk, interactive TV, set top box, and the like. In this manner, host system 20 offers customers the convenience of having only a single profile in host system 20 that can be utilized at all participating ATM's with just one login and with only one login number.

A customer enters a customer identifier at ATM 12 prior to entering the desired booking information. In one embodiment, the methods and systems of the present invention offer services to a customer who is an ATM card holder with a profile stored in database 28 of host system 20. In one embodiment, on a previous occasion the customer has registered with host system 20 by means of the internet, and has input his preferences in his profile, which can be, by way of illustration in the example of travel, meal preference, seat preference, and the like. The profile section is designed to store the customer's details as well as those of his family and friends (collectively the “Customer's Associates”). At ATM 12 the customer can make a booking for his Customer's Associates Bookings of only the Customer's Associates can be done when their profiles are input into the host system.

The customer starts the process by inserting a standard ATM/debit/credit card into an ATM. For purposes of this specification an ATM is as described in Hayashi, Sullivan and Weiner, A Guide to the ATM and Debit Card Industry, Apr. 7, 2003, 1:180. In another embodiment, the customer can utilize other communication devices, as described above, other than an ATM, to do the booking, including but not limited to, such as the phone, internet, PDA, mobile, kiosk, interactive television, set top box, fax, and the like.

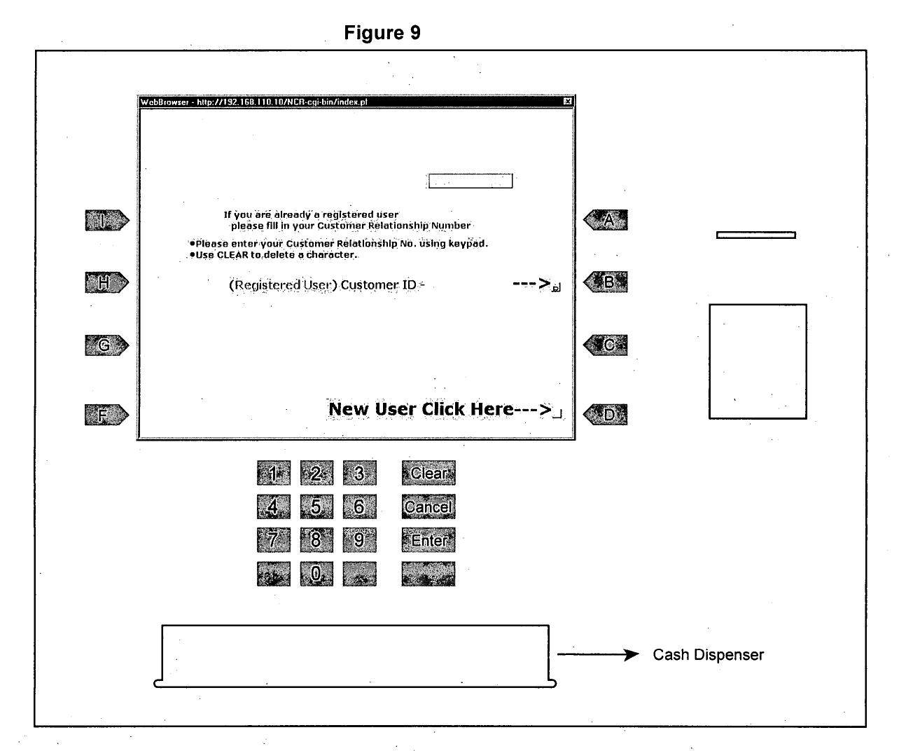

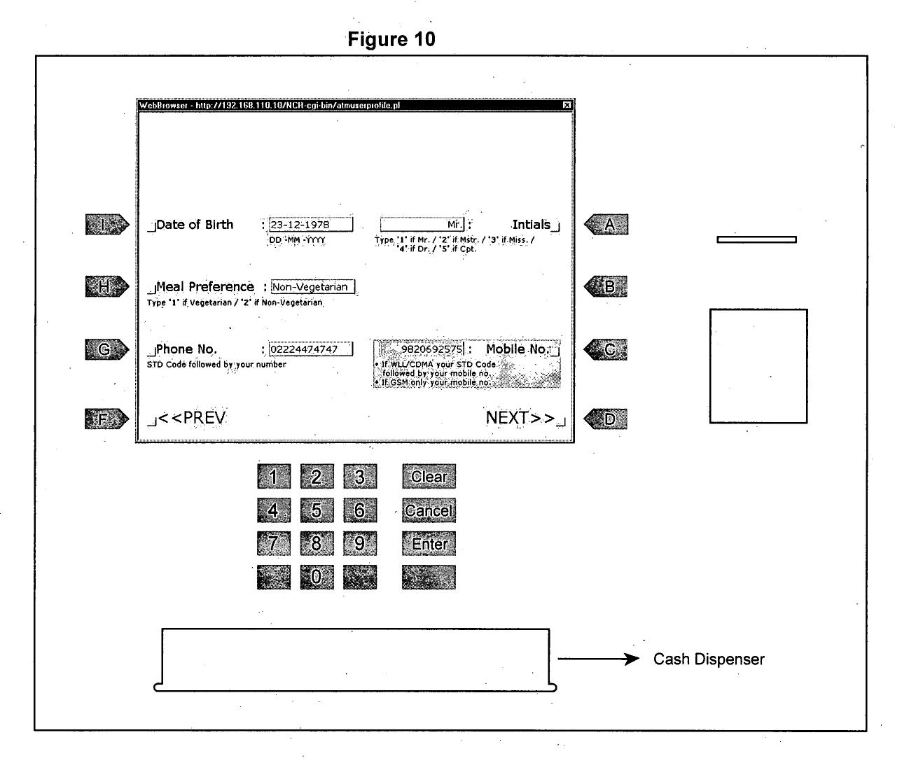

Referring to FIGS. 9 and 10, apart from the normal options to withdraw money and view account balance, the customer is offered options to make bookings, including but not limited to travel purchases. In one embodiment, customers register with the host system before they can make bookings. In order to register with host system, the customer completes a profile that has a variety of information including but not limited to, age, sex, phone number(s), frequent flier information, meal and seat preferences, and the like.

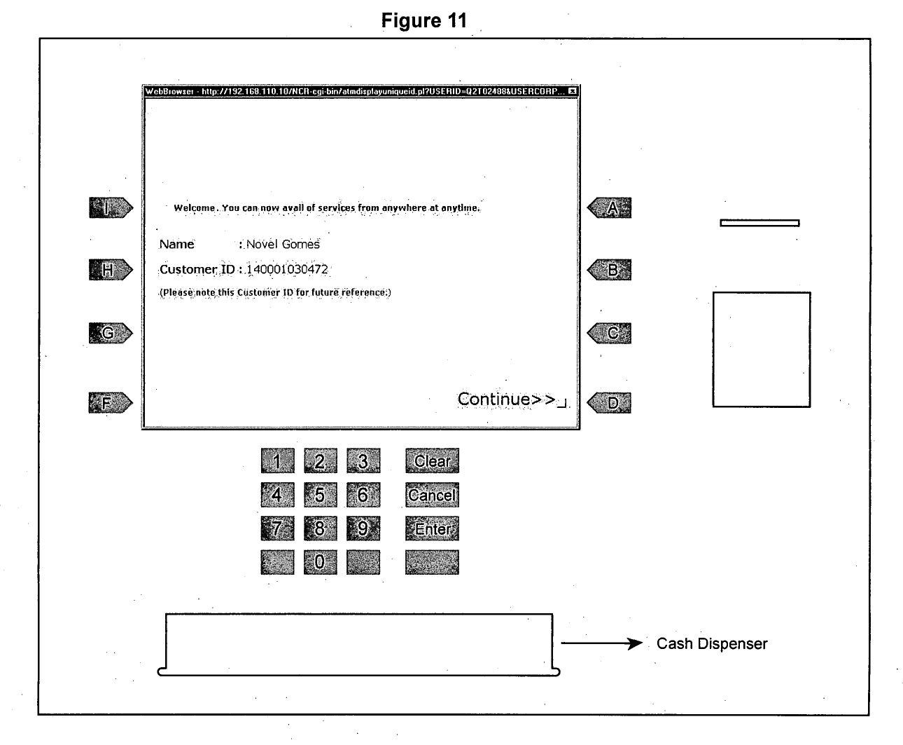

In FIG. 11, registration is completed when host system generates a random 12 digit customer number, which by way of illustration, can be a twelve digit CRN. When the customer desires access for bookings through ATM 12 or other communication device, the CRN from host system 20, helps track requests.

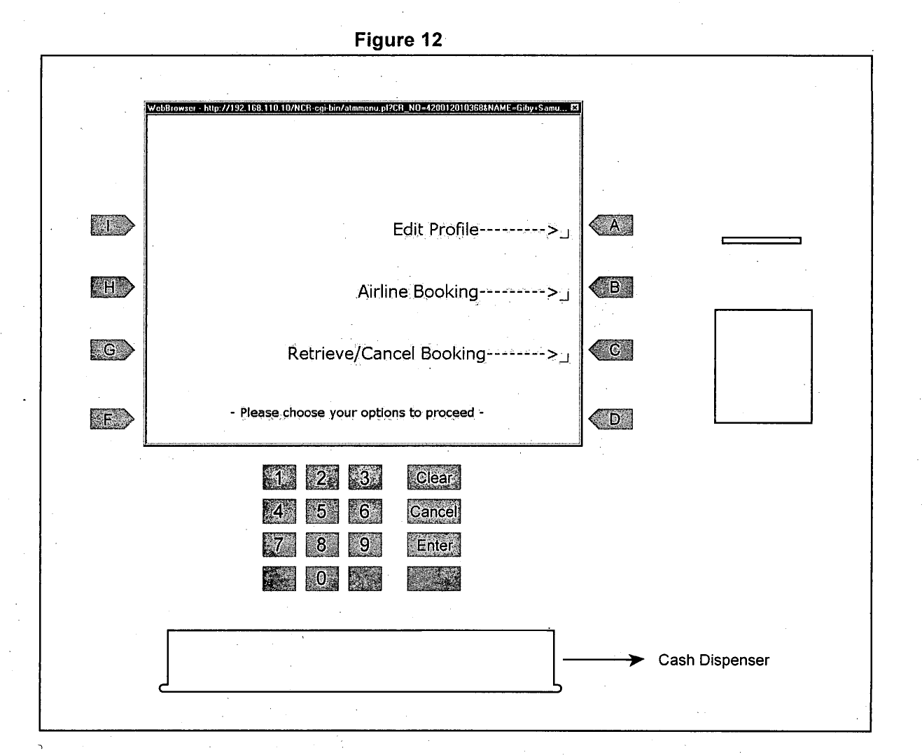

Referring to FIG. 12, at ATM 12 the customer is prompted to enter his/her customer ID number. This number is routed to the host system database where it is verified. If there is a match, and a confirmation of the customer ID number made, the customer can then utilize ATM 12's interface to selected a variety of different options, including but not limited to, editing his/her profile, making a new booking, retrieving an existing booking, and the like. At any time the customer has the ability to edit individual profiles.

A customer enters one or more booking queries at an ATM interface using FDK's 16 of ATM 12. In response to the queries, selected booking information is gathered in response to the booking query. Gathered booking information is displayed at ATM 12 interface. A booking is selected by the customer from the displayed gathered booking information at ATM 12 interface. The customer receives a confirmation of selected gathered booking information at ATM 12 interface. Interactions with the customer and ATM 12 are achieved with the use of ATM 12's FDK's 16.

The functioning of each FDK 16 on any type of ATM 12 is preset by the application running on it. See Appendix A. These applications are vendor dependent but vendors including but not limited to NCR, Inc, Dayton Ohio, Diebold, North Canton, Ohio. Wincor Nixdorf, Paderborn, Germany, Triton, Long Beach, Calif., Tidel, Houston, Tex., Fujitsu, Hyosung, Omron, Hitachi, OKI Electric, LG Electronics and the like.

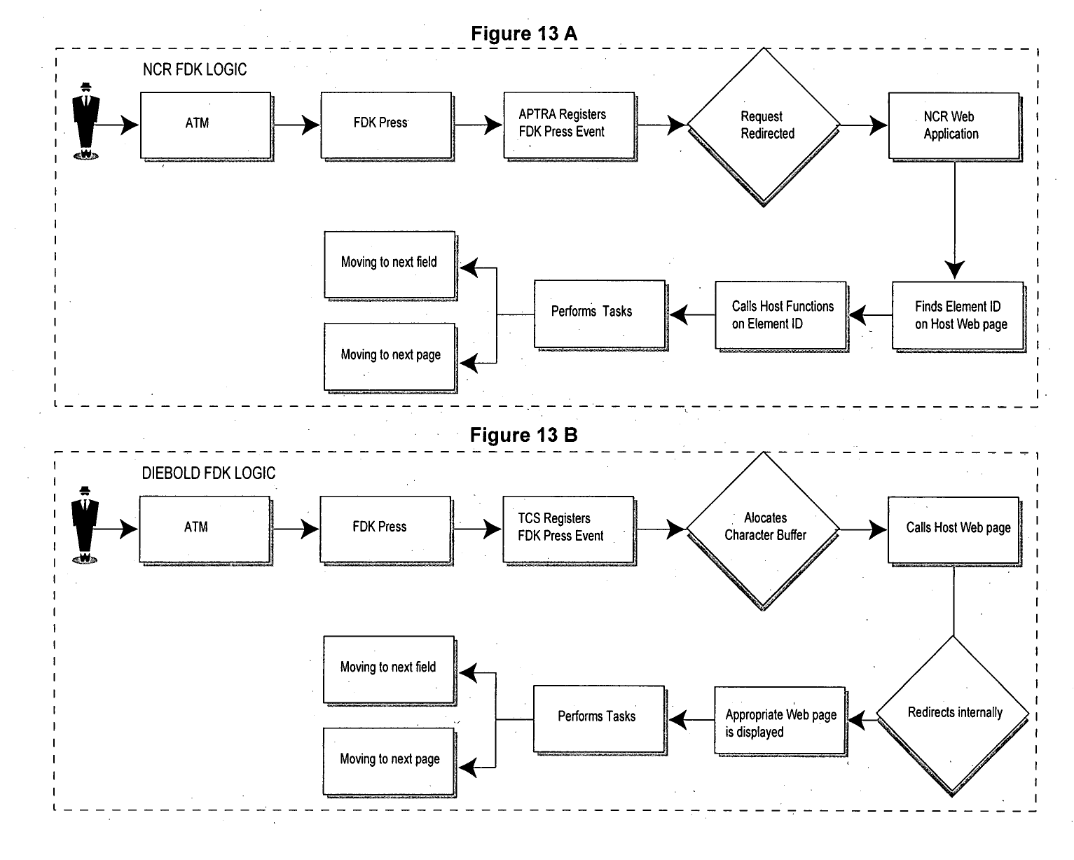

As shown in FIG. 13(a), and by way of illustration, and without limitation, NCR, Inc., uses a software program called Aptra. Aptra is an intermediate software between the web application support software that runs on an ATM 12 and the low-level hardware function calls, including those such as, FDK 16 pressed, printer problem, and the like. Only Aptra receives the notification of any event of the FDK's pressed. The NCR, Inc. web application support software calls the event of Javascript written for any FDK used. If a numeric key on an ATM 12 is pressed the web application support software looks for the HTML object having the same ID as the FDK numeric key and calls the Javascript event written on it without the web application support software knowing which FDK is pressed. Host system 12 has an application, Javascript, that needs to have the HTML objects with their ID's and the functionality written to those objects. When a FDK is pressed Aptra software calls the event of Javascript written for that FDK by host system 20. Aptra looks for the HTML object having the same ID as the FDK. The HTML objects with their Ids are written in Javascript by the host.

Referring now to FIG. 13(b), in another embodiment, the ATM 12 is supported by Diebold and uses terminal control system software (TCS). TCS is the intermediate between the web application software running on the ATM 12 and the low-level hardware function calls. In this embodiment, only the TCS software receives the notification of any event of the FDK's pressed. Diebold web application software has some predefined Javascript functions that are called whenever an event on the web application software occurs. There are functions which are called on during loading of a web page. In this case, Diebold has written Javascript functions which are called when an event occurs. This Javascript allocates buffers whenever a FDK is pressed. Host system 20 looks up the Javascript written by Diebold which allocates the buffer. When it receives the value of the buffer host system 20 knows which FDK was pressed and accordingly calls the loading of the appropriate web page.

Whenever a customer sends a request for any information to a financial service system server 36, it provides the web pages that corresponding to the FDK pressed. Apart from this if any kind of data is to be requested from the host system 20, financial service system 22 sends a request to host system 20 from where the response is taken and merged into the web page and served to the ATM 12 application, which is fixed HTML pages or pl written by host system 20, for displaying.

The task of the ATM 12 is to always requests a URL from a financial service system server 36 whenever an FDK 16 is pressed. The related information includes the CRN, and the like, and is passed from one page to another, which has already gathered at ATM 12 from the customer is sent along with the URL. The URL then understands the task to be performed based on the information gathered and accordingly serves ATM 12 with a Web Page with the requested booking information of the customer.

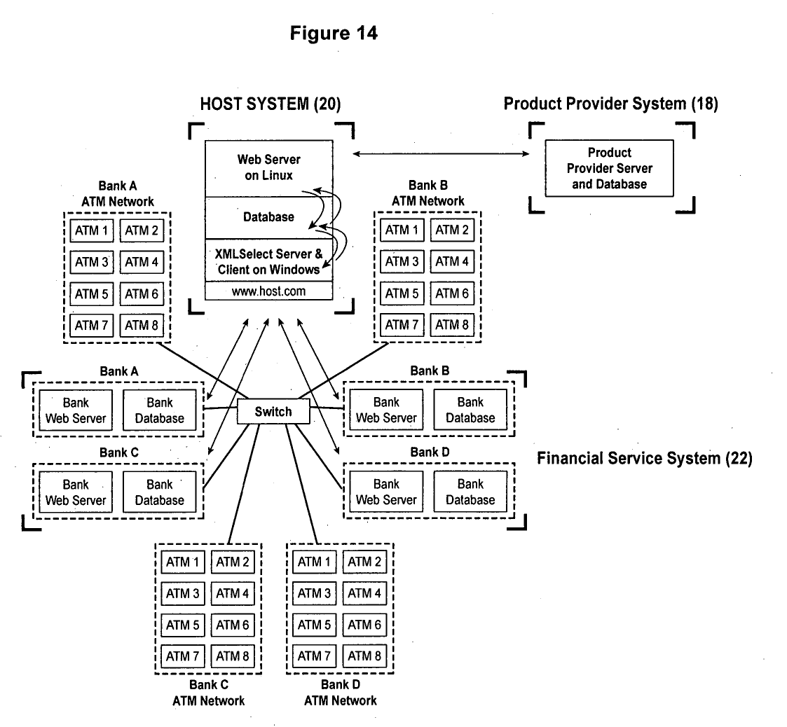

As illustrated in FIG. 14, financial institutions run their ATM's 12 on their private networks. All ATM's 12 are connected to switches 40 which in turn communicates with servers 36 of different financial institutions which are included in financial services system 22, all of which are part of the ATM sharing network. In one embodiment, host system 20 requires that, (i) the ATM operating software includes Explorer objects to be able to parse the html pages and (ii) the ATM application should be able to talk to our host web server. The first is possible on windows based machines. In one embodiment, at least a portion of software from host system 20 is loaded on a server 36 of financial service system 22, and it's associated ATM's 12 communicate with this server.

Again referring to FIG. 5a, the each ATM 12 is connected to a financial institution switch 40 and to a financial service system 22 server 36. Switch 40 is connected to server 36. Server 36 is connected to host system 20. When a customer makes a booking query, it is forwarded to server 36. Server 36 has a virtual directory, which is allocated to host system 20. In this virtual directory, host system 20 stores web pages and an XML file containing the profiles of customers. The data from this file is updated on host system 20 and vice versa at regular intervals. Host system 20 can access only this virtual directory on server 36 and not the entire financial institution web server.

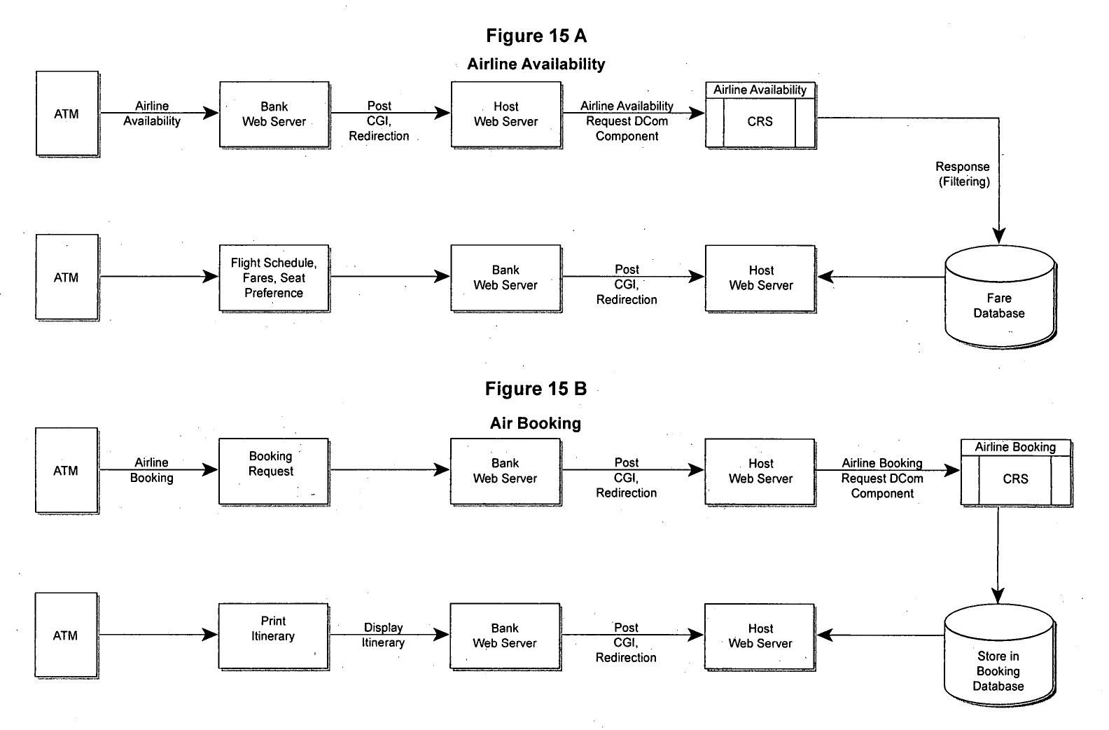

As shown in FIG. 15(a), when a customer selects booking information, such as city and date of departure, destination, class of travel, and the like this information is stored in a cookie at ATM 12 and also in the virtual directory on server 36. Database 28 of host system 20 is hit only for availability and booking. Host system 20 sends the request to the CRS 30, receives the data from CRS 30, filters it, attaches fares from database 28 and sends the data to the virtual directory, which is then displayed on ATM 12. Once the customer chooses an option and says BOOK, host system 12 is accessed through server 36 after a transaction ID is created. Again host system 20 connects to CRS 30, sends all data required to create a PNR. CRS 30 responds by generating a PNR. The PNR is an indication of a confirmed booking having been made as per the customer's choice. The booking details are now stored in database 3 of host system 20 and sent to the virtual directory. When the customer chooses to BUY the selected option, the request is then sent to the switch 40 with the purchase amount and transaction ID and the account number of host system 20. If the balance in the customer's account is sufficient, the transaction goes through and a receipt is printed with the itinerary, transaction ID, and the like. In case of a failure due to insufficient balance or a problem with printing the receipt, the transaction is reversed and the PNR is released.

In another embodiment, illustrated in FIG. 5b, ATM 12 is connected to switch 40 and a special web server 42. Switch 40 is connected to server 36. Special web server 42 is connected to host system 20. Special web server 42 is put up in case the corresponding financial institution does not want to give a virtual directory to host system 20 on its server 24. Special web server 42 acts like the virtual directory does in scenario the preceding embodiment. Special web server 42 is put up in the bank premises and is connected to server 24 of host system 20 via a leased line or similar device.

Whenever the customer selects an airline booking, the query is sent to special web server. In special web server, host system 20 stores web pages and an XML file containing the profiles of host system 20 customers including but not limited to, customer relationship number., card no, name, and the like. The data from this file is updated on host system 20 and vice versa at regular intervals.

When a customer selects city and date of departure, destination etc, this information is stored in a cookie at ATM 12 and also in special web server 42. Database 28 of host system 20 is hit only for availability and booking. Host system 20 sends the request to CRS 30. Host system 20 receives the data from CRS 30, filters it, attaches fares from database 28 and sends the data to special web server 42, which is displayed at ATM 12.

FIG. 15(b) shows that once the customer chooses an option and says BOOK, host system 20 is accessed through special web server 42 after a transaction ID is created. Again host system 20 connects to CRS 30, and sends all data required to create a PNR. CRS 30 responds by generating a PNR. The PNR is an indication of a confirmed booking having been made as per the customer's choice. The booking details are now stored in database 28 of host system 20 and sent to the special web server 42. When the customer chooses to BUY the selected option, the request is then sent to switch 40 with the purchase amount and transaction ID and the account number of host system 20. If the balance in the customer's account is sufficient, the transaction goes through and a receipt is printed with the itinerary, transaction ID, and the like. In case of a failure due to insufficient balance or a problem with printing the receipt the transaction is reversed and the PNR is released.

In one embodiment, any bank application which needs to display the web page loads Microsoft Internet Explorer Object to allow functionality, including but not limited to, Internet Explorer, e.g. the parsing of the HTML tags, the Javascript functionality, events, and the like. The software of the particular ATM 12, should be able to load the explorer object. In this regard it is similar to the explorer browser but is meant for dumb terminals which do not have a mouse to navigate. By way of illustration, parsing of HTML tags means bHotel will mean Hotel in bold uhotel will mean hotel which is underlined.

In various embodiments, host system 20 application is designed to do various tasks, including but not limited to automatic redirection of the web page as the transaction on ATM proceeds. Host system 20 application stores the values, which by way of illustration for an airline booking can be the customer's name, city of departure, city of destination, dates of travel, class of travel, and the like, in the cookie of ATM 12, receives the customer inputs from the buffer and displays it in a formatted way in appropriate fields at a display 14 of ATM 12. The data input by the customer after choosing the airline booking is stored in a cookie in ATM 12 and is sent to host system 20 at the time of booking.

With the methods and systems of the present invention, the ATM's 12 used are typically cash dispensing devices that are continuously connected to one or more financial institution's network. ATM 12 is connect to switches which in turn are coupled to at least one host financial institution. ATM 12 is designed to handle minimum data and lack bandwidth. Without the methods and systems of the present invention, the typical ATM 12 communicates the customer's account and pin number and the amount he/she wishes to withdraw. In one embodiment of the present invention, ATM 12 utilized lacks a conventional keyboard and has a numeric keypad along with buttons marked “enter” and “cancel”. This type of ATM 12 is designed to accept only numeric data which is relayed to and fro through the switch to authenticate and authorize transactions. In various embodiments, ATM 12 may use either dedicated lines for connecting to the switch or dial up links.

ATM's 12 utilized with the methods and systems of the present invention, are those that are used for financial transaction initiated when the customer is asked to insert a standard ATM/debit/credit plastic card into the reader slot. These plastic cards have a magnetic strip that holds details about the customer. The first thing a customer does is enter the PIN code. Data retrieved from the magnetic strip, along with the PIN code, is authenticated, and based on approval the customer is allowed to access further financial services. Typically, the customer's interactions are restricted between withdrawing money, viewing an account balance and transferring funds to other accounts. At the end of the transaction a transaction report/receipt is generated by ATM 12.

In various of the methods and systems of the present invention, a series of software interfaces are provided that can allow customers to make real time bookings on ATM 12. In various of the methods and systems of the present invention, a series of software interfaces are provided that can allow customers to make real time bookings on ATM 12.

In one embodiment, database driven interface is utilized to a live reservation system for airline bookings to ensure validity and a strong back-end to ensure timeliness and accuracy. The systems of the present invention accept inputs from customers, route the inputs through host system interface with a live real time reservation system, and present a variety of options based on these customer inputs. Based on the customers selection the data required to make a confirmed booking is once again fed into the reservation system that results in a passenger name record (“PRN”). System 10 can debit the cost of the purchase automatically either directly to the customer's account and/or to the credit card account.

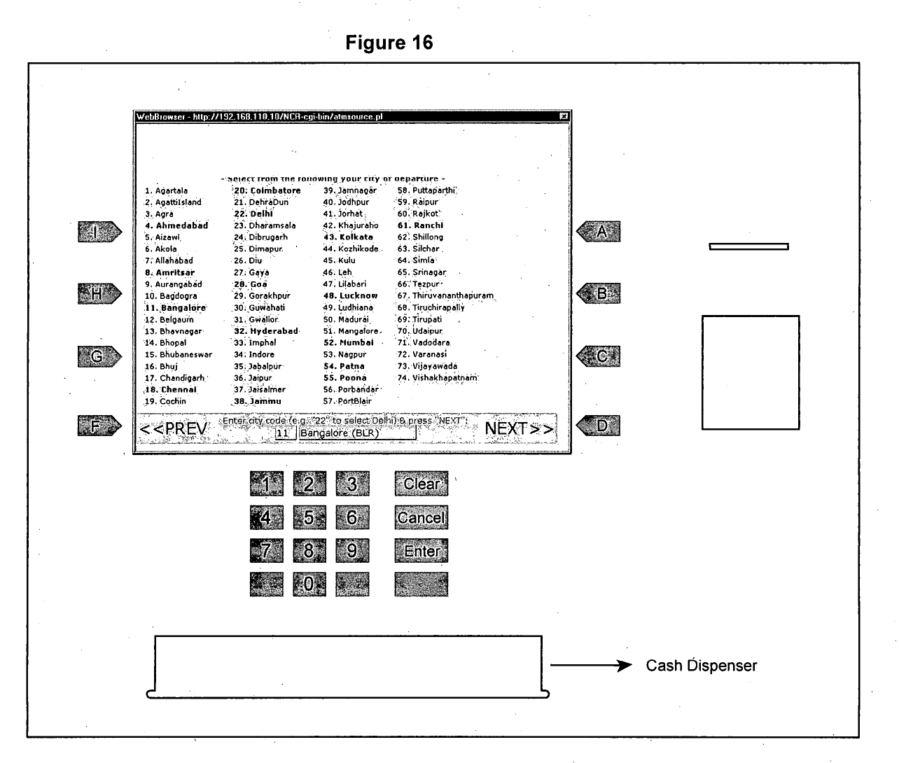

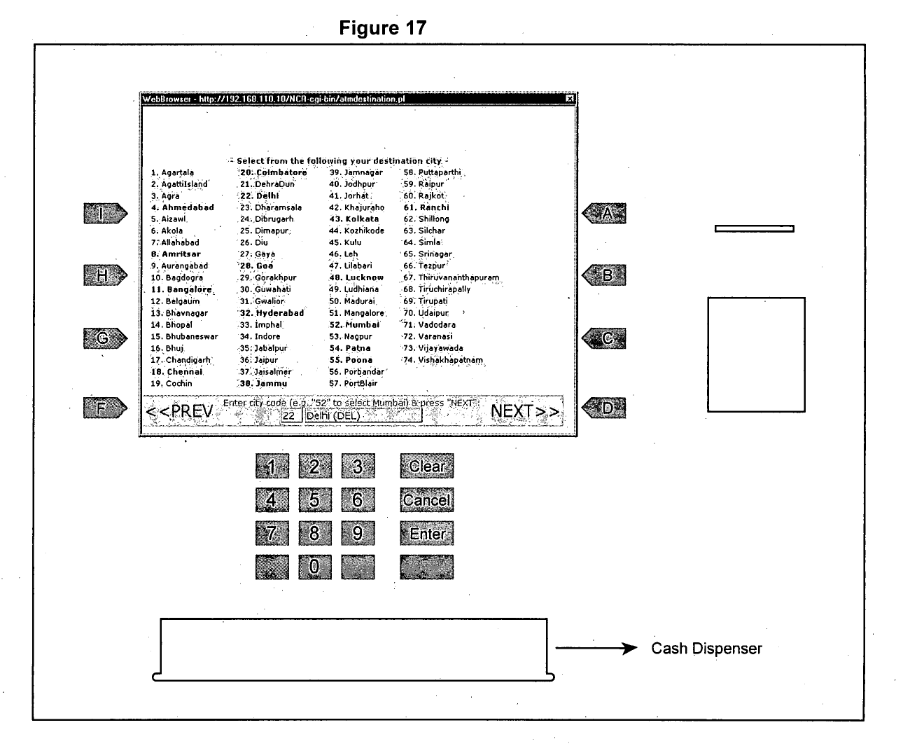

In one specific embodiment, the booking is for airline travel arrangements. A customer makes a request, at ATM interface 12, for information relating to air travel. A variety of different events then occur. ATM interface 12 is connected to host system 20. In response to the customers query, host system 20 sends a list of departure cities and destinations to ATM interface 12 where they are displayed, as illustrated in FIGS. 16 and 17.

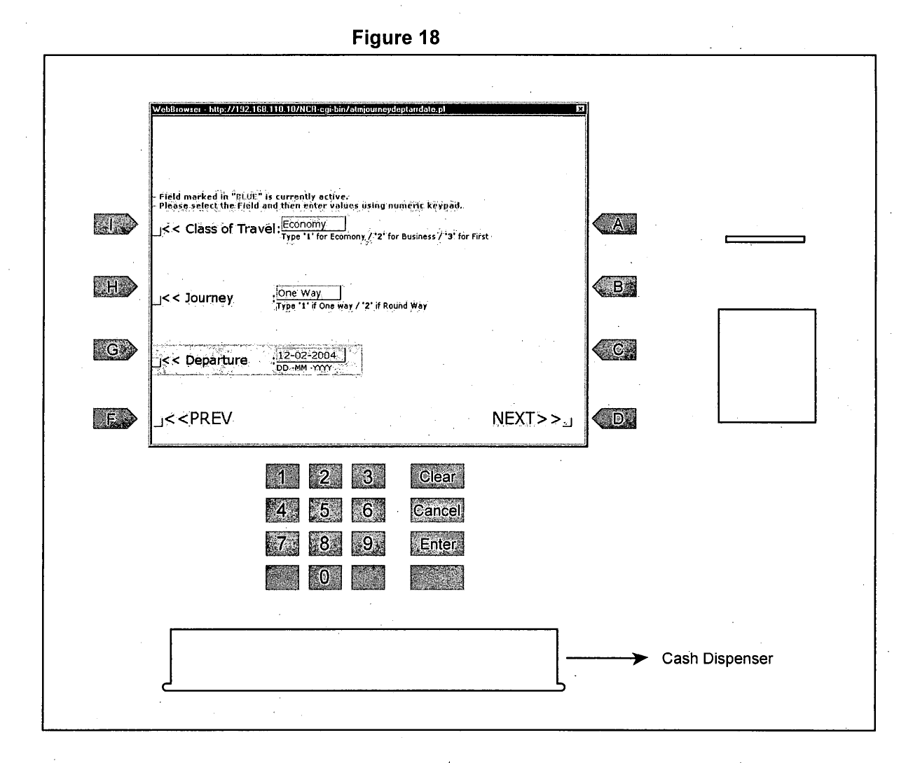

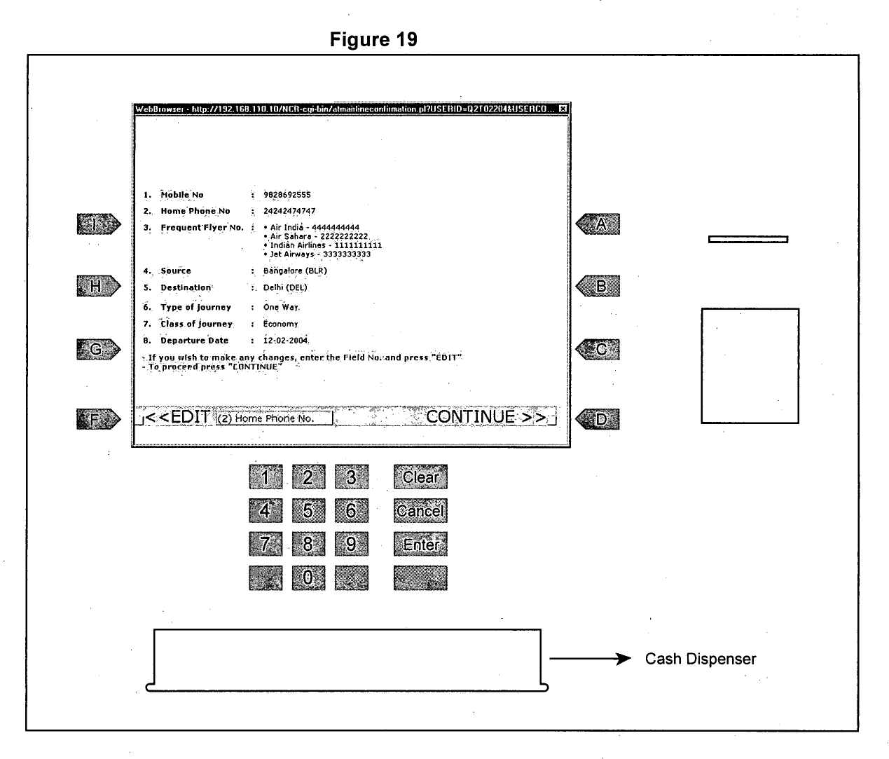

As shown in FIGS. 18 and 19, for an airline booking, all of the customer's information for that booking is entered at an ATM 12 and is routed to the CRS 30 in a format that a CRS server can process. This is the information that is necessary to request a successful booking and is relayed to CRS 30 in a sequential manner. Individual bookings are made in CRS 30 for every passenger specified. The booking code for the related fare is retrieved from the database 28 of host system 20.

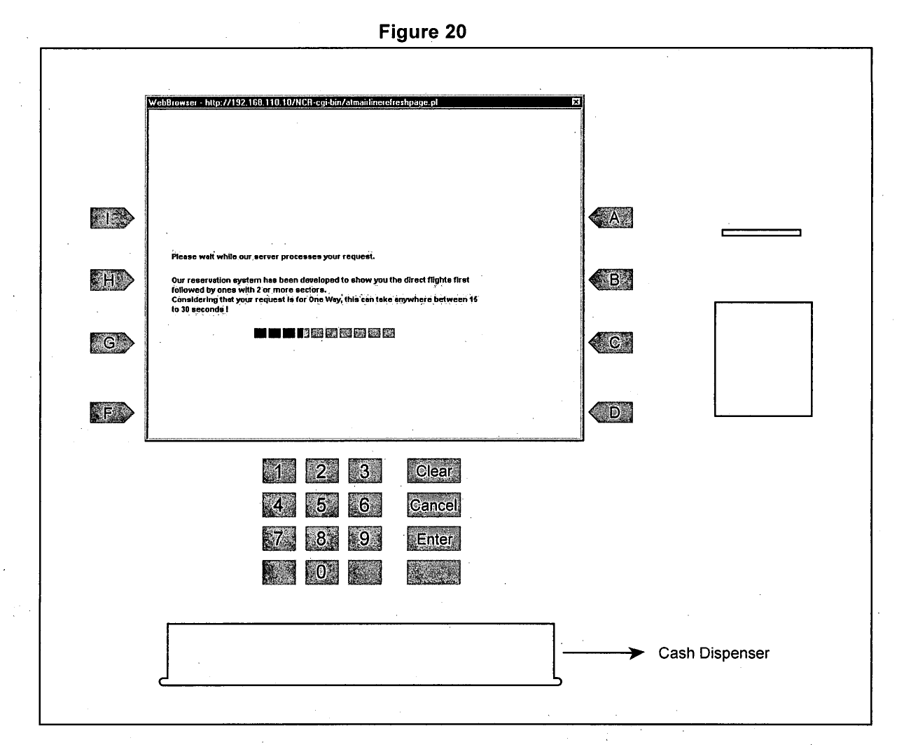

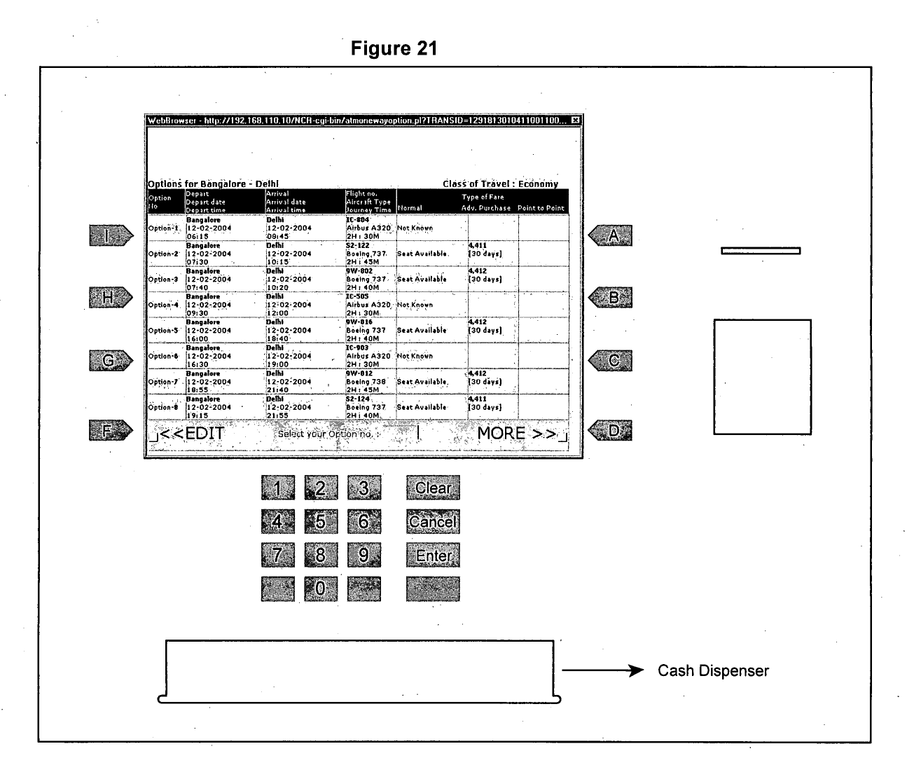

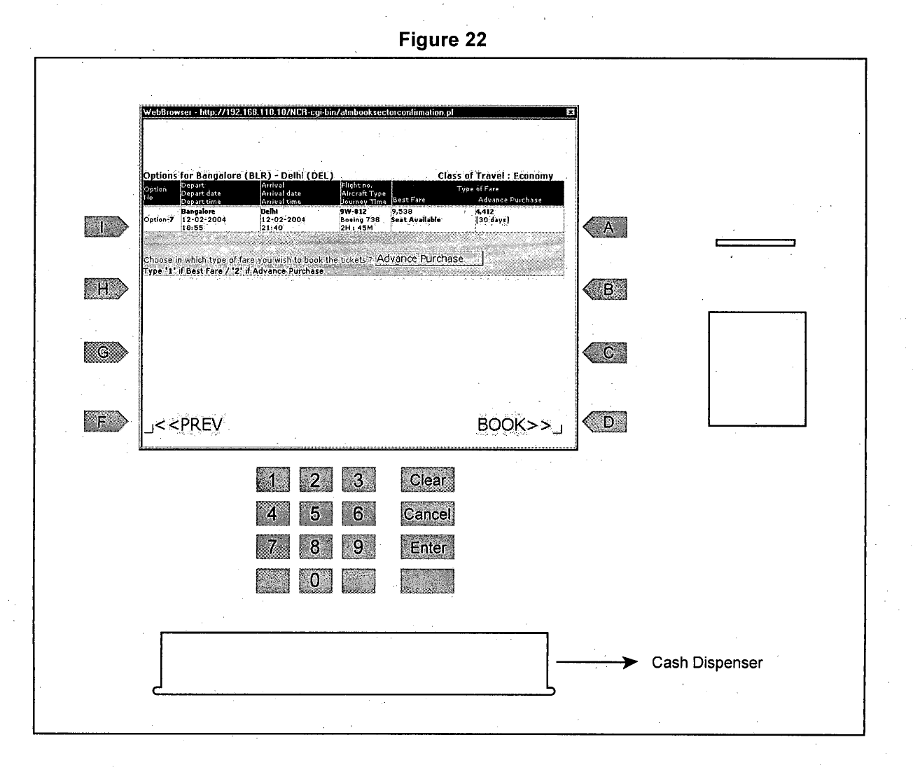

In FIGS. 20, 21 and 22, the customer can view all their choices before doing his booking at ATM display 14. When a customer submits a query to fly between two or more destinations, host system 20 routes this query to reservations server 26, sorts the data that is polled, attaches fares and accompanying rules, and displays it at the user end showing the various options to fly on direct flights first, followed by ones with one and more stopovers. Based on what the customer selects, host system 20 picks up the relevant customer data and preferences from database 28 and feeds it to reservation server 24 in a predetermined sequence resulting in a PNR being generated.

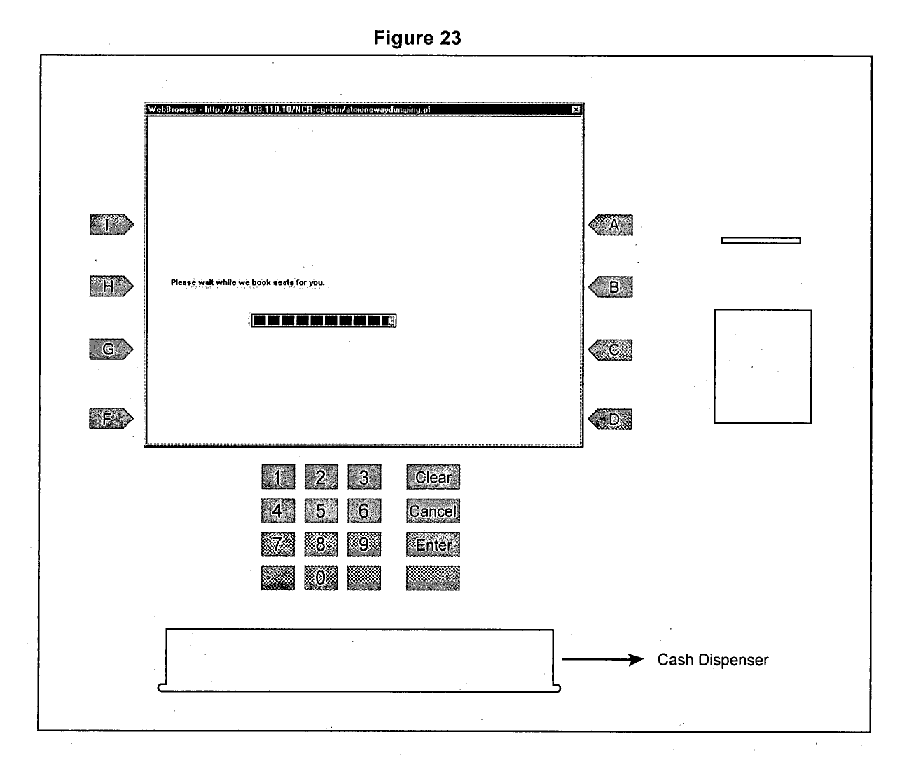

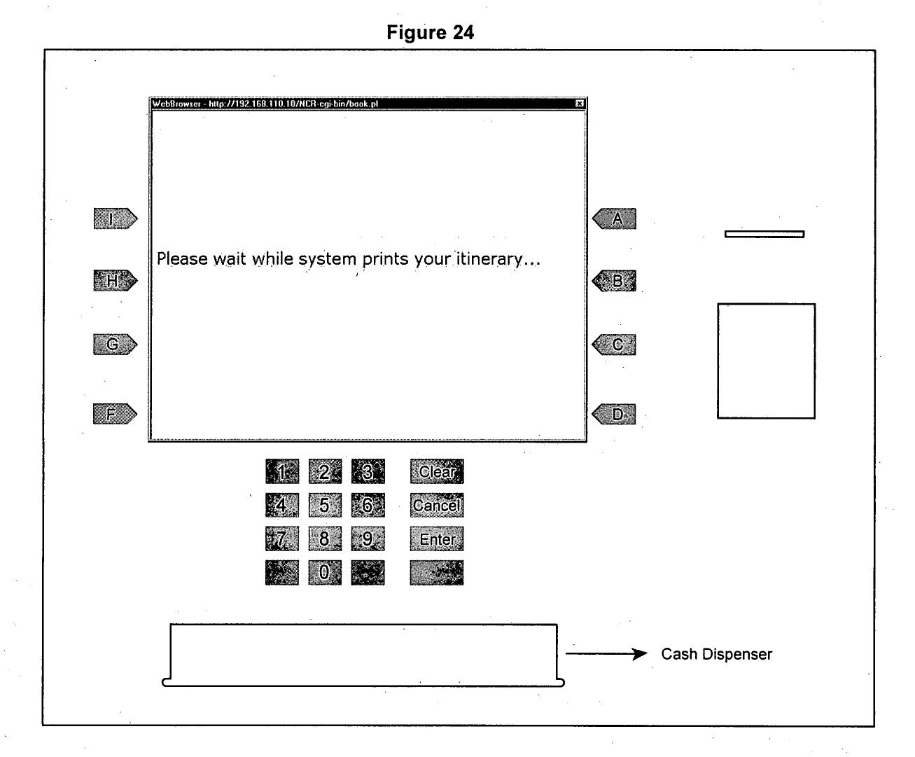

As illustrated In FIGS. 23 and 24, seats are confirmed at CRS 30 after which the seat status without the PNR is displayed. The customer has the option to either buy the seat or cancel the transaction. An indication of a successful transaction is returned which then sends a request to server 24 of host system 20 for the itinerary and for passing the sequential ticket number, which is already in database 28. Receipt of the ticket number confirms to the airline that it is a valid booking. This itinerary contains all the information along with PNR Numbers, and transaction identifier, and is generated by the host system 20.

There are two kinds of PNR's that are generated during the process of making a booking, and both are known only to host system 20. The first is the reservation system's PNR which can be viewed only by host system 20. The other is the airline PNR which can be retrieved by any qualified vendor. The airline PNR is the most sensitive data field in the entire reservation process. Generation of an airline PNR is evidence that the reservation has been successfully completed and is also reflected in the airlines database.

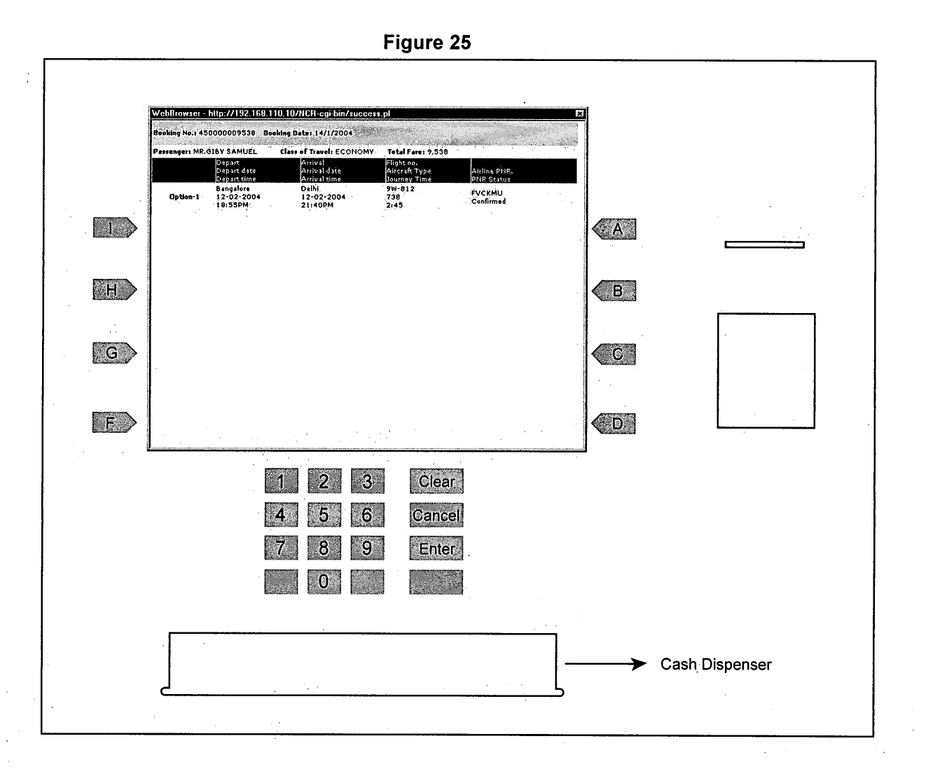

Referring to FIG. 25, the web page containing this itinerary is displayed at ATM 12 and is used for printing the receipt. The printed receipt with all the details regarding the transaction provides the final contract between the airline and the customer.

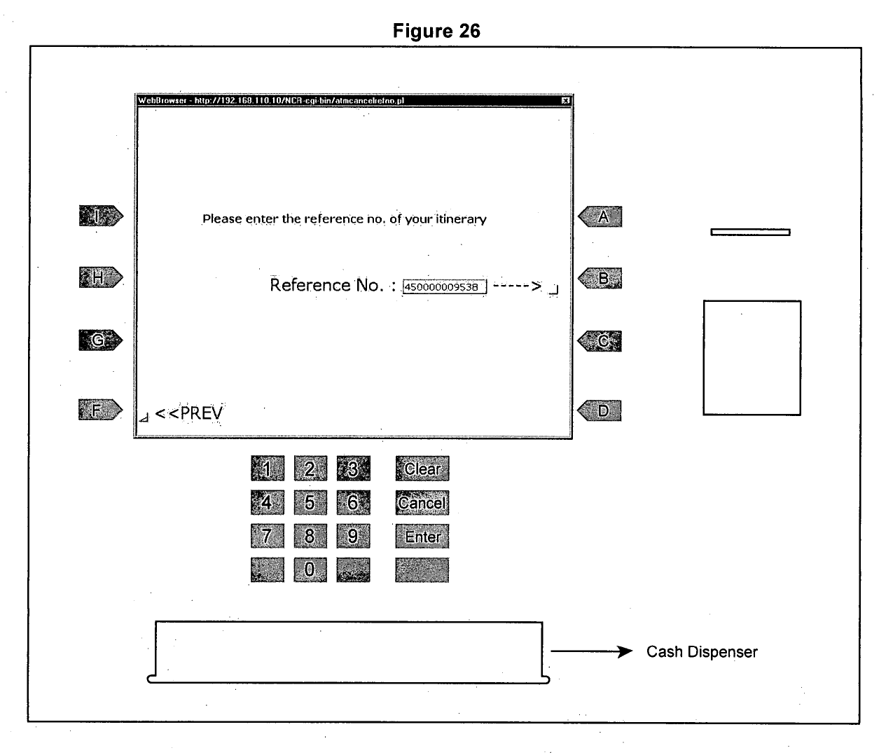

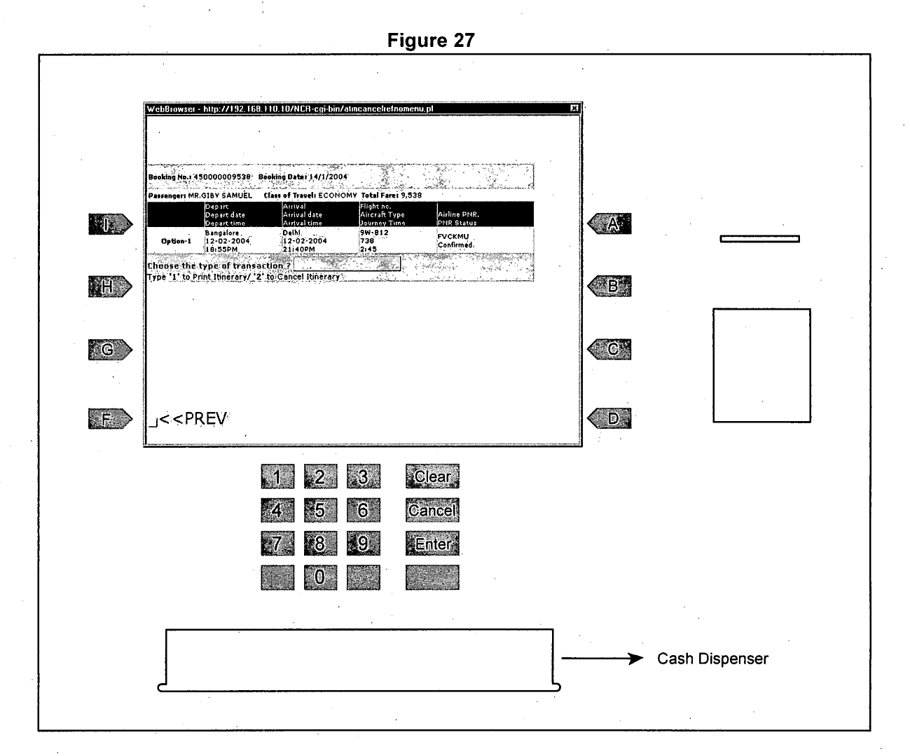

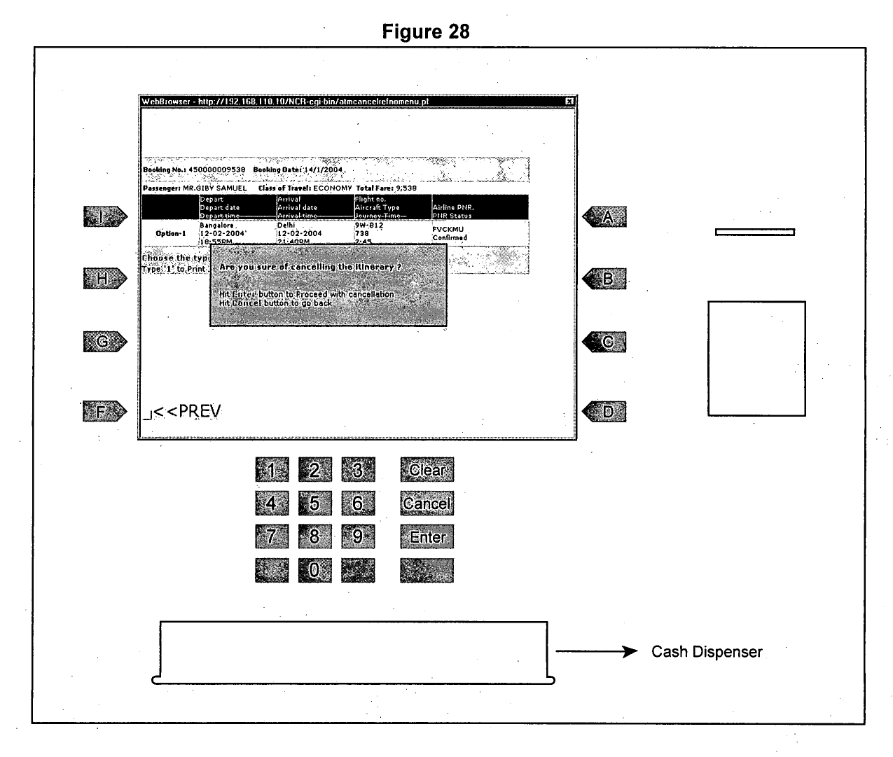

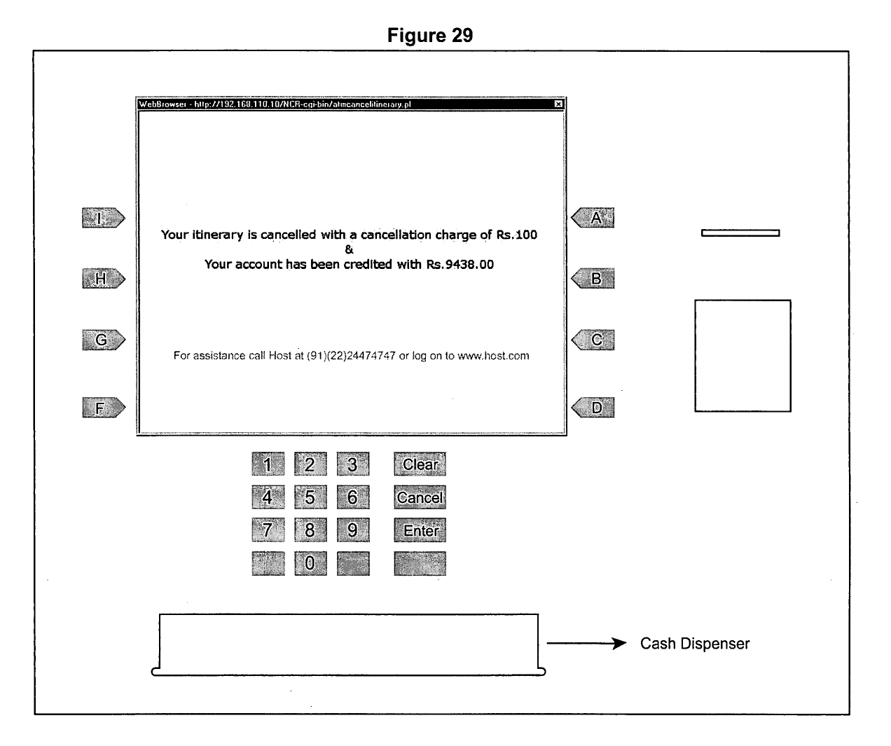

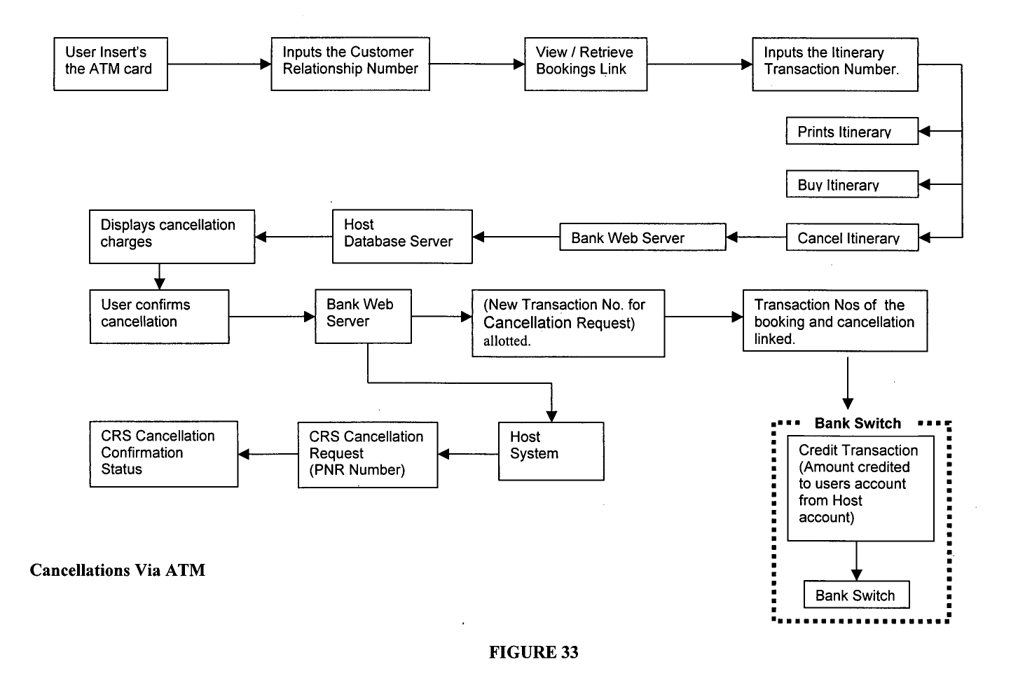

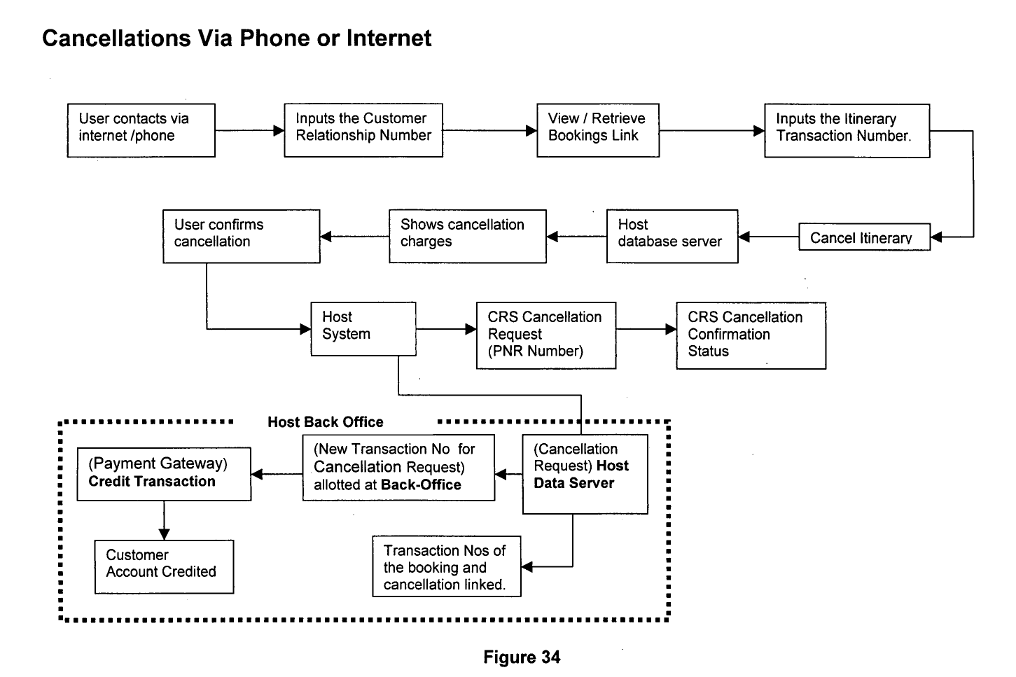

When a customer wants to cancel the purchase of a booking, details of the booking are provided by the customer and collected from server 24 of host system 20 with. If the customer chooses to proceed with the cancellation, the details of the transaction are relayed to a reservation server 26 of host system 20, along with codes for canceling the booking. Seats are released at CRS 30 and the PNR is canceled. Details of the amount payable to the customer, along with the customer's and the account number of host system 20 are relayed to a server 36 of financial services system 22 through a switch 40 of financial provider system 22. The account of host system 22 is debited to the extent of the value of the customers account that is credited, as illustrated in FIGS. 26, 27, 28, 29, 33 and 34. The customer is informed on display 14 and a cancellation receipt is printed.

Host system 12 database 28 contains information for various service providers for which bookings are to be acquired. Database 28 structure is designed to store product details from each provider, pricing, accompanying rules, booking procedures, refund/cancellation procedures, codes, and the like. By way of illustration, for an airline booking, database 28 includes information about various airlines, their flight schedules, routes, departure/arrival timings, aircraft types, inter airline agreements, frequent flier programs, booking codes, class structures, fares, restrictions, rules, cancellation/refund policies, and the like. For hotel bookings, host system 20 database 28 includes information including but not limited to, various hotel properties around the world, their size, grade, address, location details, types of rooms offered, facilities, rates, check in/checkout timings, mode of settlement, payment terms, and the like.

For rental cars, host system 20 database 28 includes information including but not limited to, different car rental companies, the models of cars they carry along with descriptions, address, payment terms, hourly/daily/weekly/monthly rates, mileage restrictions, pickup/drop off facilities, and the like. For insurance products and services, host system 20 database 28 includes information including but not limited to, various travel policies, premiums charged, age brackets, coverage, eligibility, waiver policies, deductibles, claims, restrictions, and the like. For consulate/embassies products and services, host system 20 database 28 has information including but not limited to, consulate timings for various countries, their locations, operating hours, types of visas, visa fees, documents required, eligibility, and the like.

Whenever a customer desires to purchase a booking he is offered a selection of products and services from database 28. Whenever a customer at ATM 12 requests booking information, either current or for a previous booking, a program associated with financial service system server 36 internally sends a request to the host system server 24 for retrieving any kind of booking information. Host system server 24 in return gives the response to financial service system 22 server 36 with related booking information. In one embodiment of the present invention, this interaction works on XML based specifications.

In one embodiment, except for the availability of bookings, all other customer interactions are handled by programs that reside on financial service system servers 36. Thus modules required for helping the customer navigate through the web pages, are hosted on servers 36 of financial service system 22 and are updated from time to time whenever the need arises.

When the booking is an airline booking, the customer selects, at a display 14 of an ATM 12, a departure city from the list of departure cities. A list of destination cities is then displayed. In any particular order, the following information can also be displayed for the customer, class of travel, e.g., first class and the like, type of travel such as round way, multiple stop over.

In one embodiment of the present invention, the lists of cities to be displayed is stored in a XML document. Every city name is assigned a three-letter city code. The XML document can be stored in the following form:
E.g. <CITY CODE=“BOM”>Mumbai</CITY> on the bank server.

This XML document is updated at a financial services system server only if there is a change in the city data. A financial services system server 36 has an associated program that parses the XML document to obtain the list of cities that will be displayed. The list of cities for departure and arrival remains the same.

Table 1, illustrates one embodiment of information needed to process a seat availability query:

TABLE 1

Class of travel
Press “1” for Economy
Press “2” for Business
Press “3” for First
Journey
Press “1” for One-way
Press “2” for Round-way
Departure Date
Format (DD-MM-YYYY)
Arrival Date (Only for round-way)
Format (DD-MM-YYYY)

A processor 44 of host system 20 displays the availability of the web pages on displays 14 of ATM's 12 for receiving inputs. With host system 20 the click of any FDK 16 the respective fields get activated and highlighted and inputs can then be received.

With reference again to FIG. 3, every ATM 12 has a total of eight FDK's 16, four on each side of the screen. The two at the bottom on each side allow the customer to either move to the next screen or to the previous one. ATM 12 has a numeric keypad with digits zero through nine and two buttons marked “enter” and “cancel”. The input fields on the display 14 align to one or more FDK's 16. The customer is first asked to enter his selection by punching a numerical value corresponding to the field in question and then to press the FDK 16 next to it. Host system 20 includes software that is designed to understand which FDK 16 is pressed.

Standard, or conventional ATM's 12 are not designed to take alphabetic characters as input, host system 20 provides pre-defined menus for some field which is then activated for receiving customer inputs. The customer makes a choice from these pre-defined menus. The information gathered for a request is then routed from a financial services system server 36 to a server 24 of host system where it is further processed and converted to a query that is understandable by CRS 30. The response from CRS 30 is parsed, filtered and in the case of an airline, a fare is then calculated. A host program on bank server 36 parses the output in such a way that it becomes clear for the customer to read the options. The options displayed may be arranged by a variety of parameters. For airline bookings, these can be in the form of, departure time, price, availability, travel time, minimum connections; and the like.

A travel itinerary is produced by host system 20 and is presented to the customer at ATM interface 12. This itinerary can be edited by the customer to make changes. The itinerary, with edits if any, is forwarded back to host system 20. Host system checks the availability of the itinerary of the airline booking. After the availability is confirmed, the itinerary is displayed at ATM interface 12. The customer can accept or reject the itinerary. The customer can book and issue the itinerary, or book and hold it. If it is accepted, host system 12 books the itinerary. Purchase of a booking creates a transaction between the customer and a booking provider, such as airlines, and the like.

Editing an itinerary allows a customer to make changes in the travel sector or travel dates. The details of every purchased booking are stored in database 28 of host system 20 and can be accessed through an ATM 12 or other communication device described above. Before editing, the customer retrieves the itinerary, as illustrated in FIGS. 12 and 26. The customer then requests to make edits and is presented with a new set of selections which are displayed. The customer makes his choice of booking option, which is then maintained in a hold status while host system 20 processes the new selected booking.

When the customer needs to edit the itinerary the rules regarding the fare in which the ticket was booked are recalled. Changes in itinerary are offered only if the fare rules allow the customer to make changes. If the Customer chooses an option that has lesser fare than before then host system credits the difference in fare to the customer's account. If the new booking is more expensive, then the difference is debited from the customer's account.

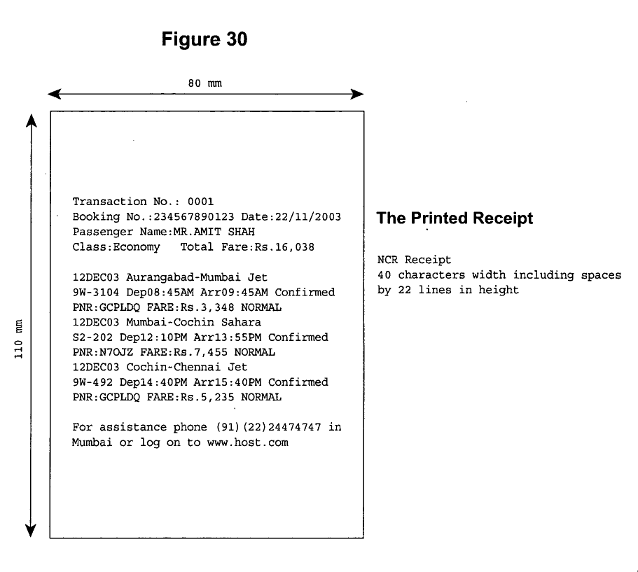

The itinerary is a web page with booking information. In the case of an airline booking, the booking information can include, a CRS PNR Number, airline PNR Number, fare, sectors booked, status of seat which is generated when a seat is booked for the customer, and the like. Depending on whether a customer is currently booking, or wants to retrieve an old itinerary, the request is processed. On embodiment of an itinerary is illustrated in FIG. 30.

When a customer requests a booking, the booking request is sent to a server 24 of host system 20 where it is further processed and the seats are confirmed at CRS 30 after which the status of seat without the PNR Number is displayed. The customer has the option to buy the seat or cancel the transaction. On pressing of cancel the booking is released automatically. When the customer presses “buy” the request is routed to the switch for PIN number verification and debit transaction. An indication of a successful transaction is returned which then sends a request to server 24 of host system 20 for the itinerary and for passing the ticket number, which is already in the database, and confirms with the airline that it is a valid booking. This itinerary contains various information, including but not limited to, place of departure, destination, dates, time of departure and arrival, airline flight no. airline PNRs, CRS, PNR, transaction ID, and the like, which is automatically generated by host system 20. The web page containing this itinerary is then displayed at a display 14 of an ATM 12.

When a customer wishes to retrieve an old booking, the request is sent to the server of host system 20 for the associated itinerary of the old booking. This itinerary contains the relevant information of, place of departure, destination, dates, time of departure and arrival, airline flight no. airline PNRs, CRS PNR, transaction ID etc, and the like, that is generated by host system 20, and returned so it can be displayed on a display 14 of ATM 12. The web page containing this itinerary is displayed on the display 14 of an ATM 12.

The customer can use ATM 12 for payment of his purchase of the booking by debiting the amount directly to his bank account or charging it to a credit card. If it is to be debited to the customer's account host system 20 checks to see if the customer has a sufficient balance in the account to be able to make the purchase. If so the amount is debited from the customer's account and transferred to the host system's account. If the funds in the customer's account are less than the value of the intended purchase the booking is released and the PNR is cancelled. The customer receives a message at a display 14 of the ATM 12 listing insufficient funds as a reason for disallowing the sale.

If the customer uses a credit card, details of his credit card along with the host system 20 merchants establishment number, and the purchase value, are relayed to the card issuer where authentication is required to charge the transaction. If authenticated, the amount is charged to the card and transferred to the account of host system 20. The itinerary with the PNR is displayed to the customer and routed to the built-in printer at ATM 12 for printing. If authentication is denied the same is displayed to the customer and the booking and PNR are released.

For airline reservations, host system database 28 can include all data regarding airlines, hotels, car rental companies, insurance, foreign exchange, consulates/embassies, airport information, and the like, in and around various countries across the globe. A team of qualified personnel ensures that host system database 28 is kept up to date at all times. Access controlled modules 30 allow authorized persons to edit/add/delete information on a second to second basis. The team is constantly in touch with the different vendors and information from product provider system 18 regarding how products and/or services are classified, sorted and fed into database 28 of host system 20, which can be by way of illustration can be an Oracle database, in a systematic manner.

By way of illustration, and without limitation, in one embodiment, product provider system 18 provides travel information and can include a variety of different modules. One module is an airline module that includes information about various airlines, their flight schedules, departure/arrival timings, aircraft types, inter airline agreements, frequent flier programs, booking codes, class structures, fares, restrictions, rules, cancellation/refund policies, and the like Similarly a hotel module can include information on various hotel properties around the world, their size, grade, location details, types of rooms offered, facilities, rates, checkin/checkout timings, and the like. A car rental module can include information regarding different car rental companies, models and makes of cars, descriptions, hourly/daily/weekly/monthly rates, mileage restrictions, pickup/dropoff facilities, and the like. An insurance module can include information for travel policies, premiums charged, age brackets, coverage, eligibility, waiver policies, deductibles, claims, restrictions, and the like.

A consulate/embassies module can list information regarding consulate timings for various countries, their locations, operating hours, types of visas, visa fees, documents required, eligibility, and the like.

For airline bookings, the following terms are utilized:

Booking Class: Represents the class of travel. For domestic air travel most airlines only offer economy and business class seating. In the case of international travel, the customer usually has the choice to choose economy or coach, business class or first class.

Ticket Validity: This represents the duration of stay allowed in which the airline tickets are valid. In international travel this can be, by way of example, 3 to 6 months, and up to a year. Fares are usually influenced by ticket validity. In the case of round trip or return tickets the passenger is expected to complete his return journey within the validity period.

Airlines use different kinds of fares to market their services. By way of example, and without limitation, the following is a listing of different kinds of airline fares:

Normal Fare: This is a standard one way fare to fly a selected, corresponding sector.

Special or Promotional Fare: As the name suggests this fare is available for a specific period to compensate for certain conditions and is lower than the normal fare.

Flight Specific Fare: As the name suggests this fare is only applicable when traveling on specific flights of the corresponding airline.

Excursion Fare: This fare is only applicable when the passenger is going as well as returning by the same airline. This fare is usually less than the sum of two one way fares to fly the same route of the corresponding airline.

Advance Purchase Fare: This is the advance purchase and is sometimes offered for certain sectors by the corresponding airlines. These kind of fares are always discounted, must be purchased in advance and carry a high cancellation/refund charge. Changing the flight time or the date too is sometimes not allowed once the ticket is issued. The number of seats released at this fare are limited and are sold on a first-come first-serve basis. Advance purchase fares work best when the customer is not going to cancel or make changes to flight schedules.

Point to Point Fare: It is often the case that there is no direct flight between two cities. One option is to fly out and then connect to another flight onwards from another city. This can require payment of two separate fares to fly the two sectors. Airlines offer a point to point fare that is slightly less expensive than the sum of the sector fares.

A number of factors influence the way an airline prices its tickets. These include but are not limited to, their own operating costs, their load factors, demand and supply position, pricing from competing airlines, departure and arrival time, type of aircraft, passenger conveniences offered, connectivity to other carriers, inter-airline and code-share agreements, and the like. For this reason airlines sell varying quantities of tickets in the same class at different prices. By way of example, to fly in economy class on a ticket with a four month validity there may be more than a few price points each with booking required to be made under different codes. Each of these fares has an accompanying set of unique restrictions such as, advance purchase needed, date changes allowed/disallowed, frequent flier mileage accrual permitted/not permitted, seating in specific areas, cancellation and refund rules, endorsement on partner airlines, and the like. The number of seats released at each of these fares is limited, and hence sold on a first-come first-serve basis.

In order to attract continued patronage, most airlines offer membership to their frequent flier programs. Passengers add points for every mile they fly to their account. Based on the balance customers get rewarded with either free tickets or complimentary upgrades to higher classes upon reaching specified limits. All the customer has to do is mention the membership number while making the booking to get mileage. Based upon the frequency and type of travel the customer can have either a standard, silver, gold or platinum membership each of which has an accompanying set of privileges. Often customers pay a higher fare just to get the mileage. Airlines form alliances with other vendors to offer additional incentives. These can include additional miles being credited when staying in specific hotel properties, renting car, and the like. A profile module in host system 20 allows customers to define and store information about their frequent flier membership. This information can be automatically embedded when bookings are made through system 10.

In one specific embodiment of the present invention, customers have the choice to purchase air tickets through host system 20; The customer can either make new bookings or retrieve old ones. If new bookings are selected, the customer is offered choices to choose that can include flying one way, roundtrip or with multiple stopovers. To make new bookings the customer is guided through successive displays 14 at ATM 12 with travel details about the departure and destination cities, dates of travel, booking class, number of passengers, their ages, frequent flier details, meal preferences, phone number, and the like can be gathered. This information is relayed to server 24 of host system 20 where it is processed.

In response to this customer input at ATM 12, travel options displayed at ATM 12, which can include but are not limited to, type of aircraft, departure and arrival times, pricing, seat availability, total flying time, connecting flights (if any), and the like. etc. is displayed. Every option can have a corresponding number. The customer is then directed to punch in the number to make a selection.

FDK's 16 on either side of display 14 allow the customer to toggle between displays 14. Based on the customer's selection, host system 20 picks up the relevant passenger data and preferences from the host system database and feeds it in a predetermined sequence in the CRS/GDS 30 resulting in a confirmed booking and a passenger name record (“PRN”) being generated.

The following describes the booking process for an individual for OLESelect or XMLSelect When integrating CRS 30 into business systems and processes, and to develop applications, application interface solutions are designed for by CRS 30 to enable the integration. OLESelect and XMLSelect are two such application interface solutions designed by Apollo Galileo.

OLE Select is designed to help host system 20 integrate the power of the Galileo system with an embodiment of a host system 20 that has 16-bit or 32-bit custom Windows®-based applications using structured data. Structured data is delivered using Microsoft's industry-standard Object Linking and Embedding™ (OLE) specification, commonly referred to as ActiveX.

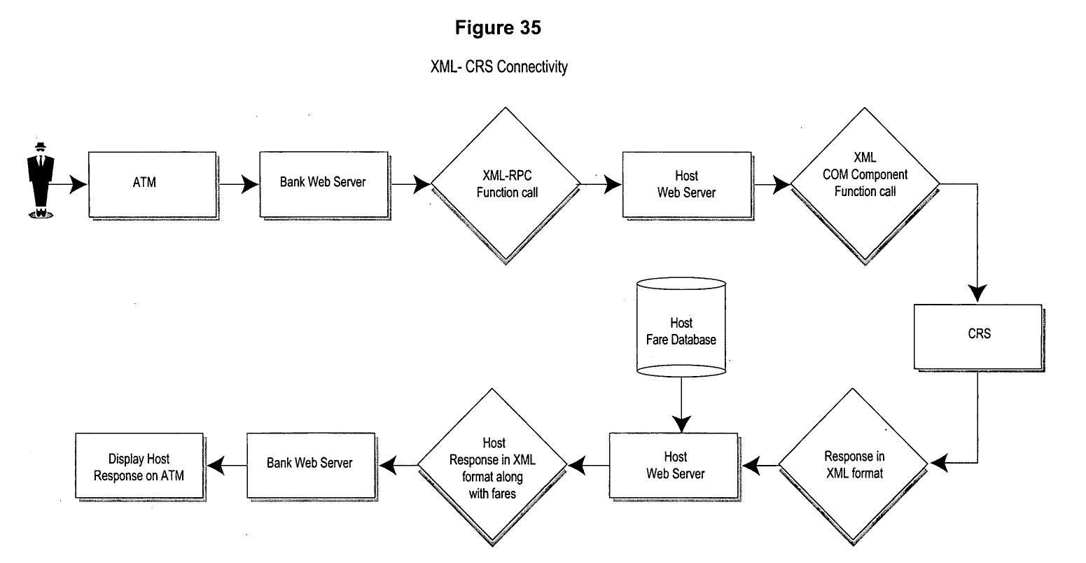

OLE Select provides host system 20 with single or multi-session capability at either the workstation or NT server level. XML Select is a structured data application programming interface (API). Using this interface host system 20 can integrate data directly from the Apollo Galileo system to create customized, high-volume server-based applications with structured data. It supports Web-based booking engines as well as server-based applications, expanding OLE Select's capabilities with the addition of XML and CRS 30 connection capabilities. The end result is a stronger, more capable Web product. See FIG. 35. A connection manager of host system 20 can simultaneously manage multiple booking sessions and provides message queuing capabilities. Similar interface options are available from CRS 30 such as those from Sabre, Amadeus, Worldspan and the like.

By way of illustration, host system 20 passes the following command, whether in OLE Structural Data Format or XML Data Format.
1. Checks For Flight Specific Query of travel date and Flight No.
2. Checks For status of the Flight
   X=Flight cancelled
   D=Flight departed
   P=Flight past scheduled departure
   N=No classes returned from link
   B=Flight boarding
   U=Flight status unknown
   Blank=Flight operational and not past scheduled departure
3. Checks For Status of Specific Class Code if present in the Flight
4. Request for Seats needed of on that flight, date & that sector.
5. If Seat is available then passes the Customer Name
6. Passes on the Customer Mobile No., Home Phone No., Office Phone No and Reference Name of the Travel-Desk Person whom the airline should contact when any problem occurs.
7. Passes validity period for the Booking, If the User Does not confirm within that validity period, the booking will be automatically released by the CRS
8. Saves the Booking & also notifies the Airline
9. Retrieves the CRS PNR No. from the response
10. Passes the command to get the Vendor Locator (Airline PNR No.)
11. Retrieves the Vendor Locator (Airline PNR No.) & also the status for each sector from the Response.
12. Saves the CRS PNR No., Vendor Locator, Status per sector to the database.

The customer can choose to either book and hold or book and issue the selection after choosing various options. The book & hold option allows the customer to make a booking and hold it. This booking is kept on hold until a specified time has elapsed. The specified time limit is calculated by host system 20 based on the time when the booking is made, and the actual travel date. If no instructions are received by the specified time limit the booking is automatically cancelled. In this circumstance, the PNR is automatically released with or without cancellation charges.

Customers can make bookings on more than one flight to fly between cities. More than one booking for the same passenger on the same flight is not allowed. Similarly when the customer requests to issue tickets all other bookings for the same date between the same destinations are automatically released by host system 20. In the case of round trips and multiple stopovers the customer also has the option to view the calculated fare for the combination chosen prior to selecting the booking. Host system 20 includes hardware and software resources that provide the customer with options to fly with the same or on different airlines for journeys covering more than one sector. For sectors where direct flights are not available system 10 can display all permutation combinations possible with one or more connections.

After a booking is selected the data for that booking is routed through a switch 40 to financial service system 22 to check if the customer has sufficient funds in his account to debit the purchase. If so the amount is debited to his account and credited to an account of host systems and a confirmation receipt in the form of an itinerary is printed, as illustrated in FIG. 30. Confirmation receipt can include a variety of information such as, the transaction number, booking reference number, booking date, class of travel, itinerary that has the passenger names, dates of travel, cities of travel, airline and flight numbers, departure and arrival times, respective airline PNR's, booking status (confirmed or wait-listed), applicable fares charged, and the like. Confirmation receipt can be utilized at the airline's counter at the airport to receive boarding passes. It will appreciated that the customer can also go to any self-help display at the airport and receive his boarding pass by utilizing required forms of identification such as a credit card. If the customer does not have sufficient balance in his account to make the purchase, other financial settlements are made or the booking is released.

Customers that want to make changes in their bookings can make them at any time at an ATM 12. Old bookings can be viewed and the modification then made. After entering the customer ID at ATM 12, the information displayed on display 14 allows the customer the choose to retrieve old bookings. All old itineraries have a corresponding number. The customer enters the number to make a selection from among the existing itineraries. The next display 14 allows the customer to choose to modify the itinerary and cancel the current booking. If the customer wishes to modify the itinerary options are provided to the customer that enable him to make changes in the itinerary, including but not limited items such as, dates, departure/destination cities, class of travel, meal request, and the like.

Based on the customer's selection, new options are displayed. Based on the option selected, new bookings are made. The customer is asked if the old booking is to be replaced. If there is a difference in price between the new and the old booking that is also displayed. Based on the customers choice the difference in amount is either debited or credited to the customers account through financial service system 22.

A printed receipt is generated that shows details of the new booking, cancellation of the old and the total amount charged to the passenger. If the customer wishes to cancel the booking the cancellations charges payable at that point in time are displayed. The amount of any refund that the customer is owed, after deducting cancellation charges pursuant to airline carrier rules, is displayed. If the customer decides to proceed, the PNR is retrieved, the booking is released and the refund amount is credited back to his account.

Similar process and displays can occur with other booking, including but not limited to those for hotels, rental cars, and the like.

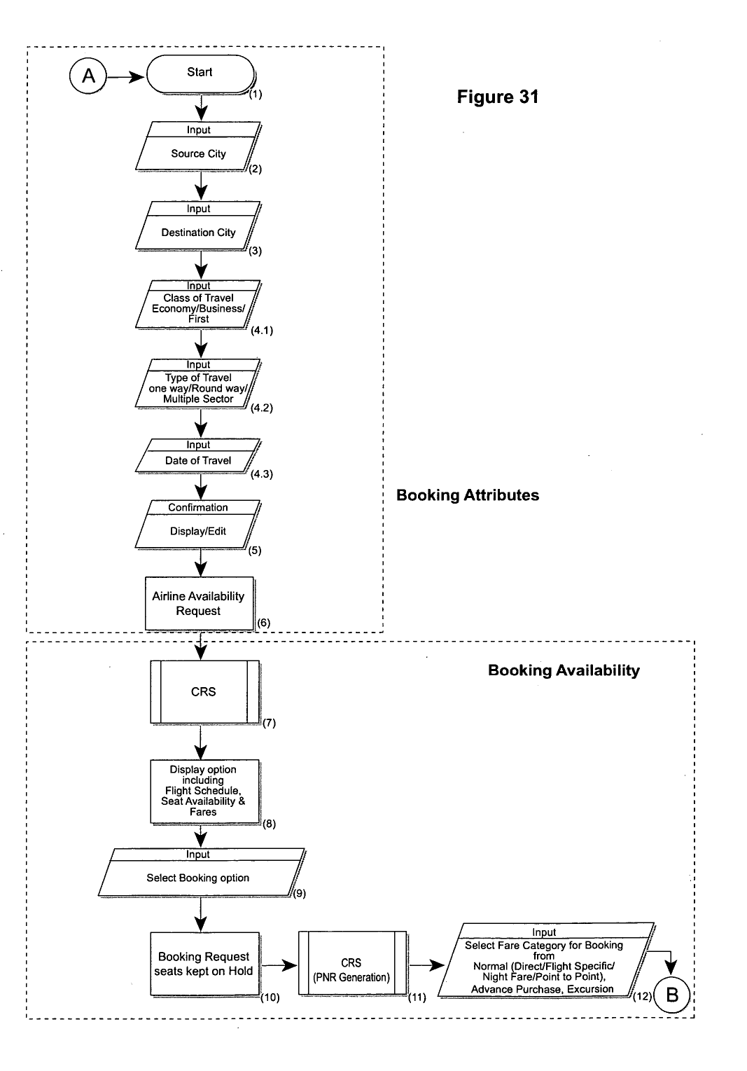

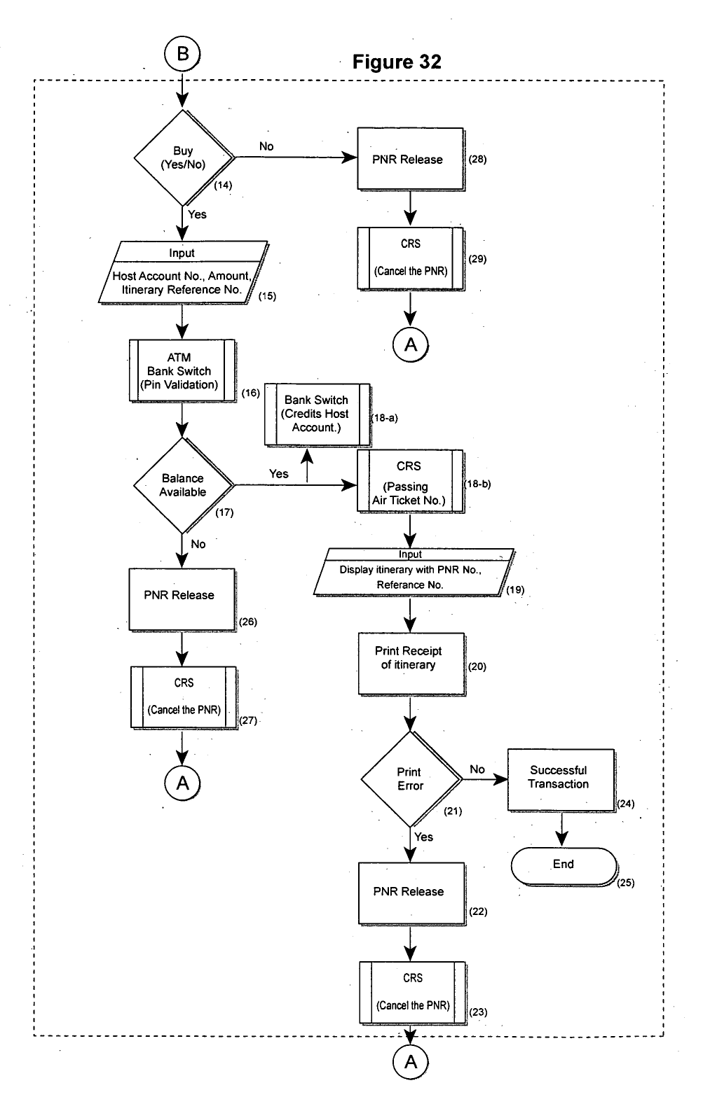

As shown in FIGS. 31 and 32, Table 2 outlines one embodiment of the methods and systems of the present invention for an airline booking

TABLE 2
AIRLINE BOOKING
ATM FLOW

(1) Start of the Airline Booking System.
(2) Input - Departure City.
On this page there is a list of cities displayed along
with the unique numbers. the customer can select the
departure city by entering the number that is displayed
adjacent to the city which user wants to select by using
the numeric keypad and select NEXT by using FDK's 16.
(3) Input - Destination City.
Again on this page there is a list of cities displayed
along with the unique numbers. the customer can select
the destination city by entering the number that is
displayed adjacent to the city which user wants to
select by using the numeric keypad and select NEXT
by using FDK's 16.
(4) Input - 3 parameters
On this page you can input 3 parameters.
(4.1) Class of Travel.
In this first row there is a list of travel class i.e.
ECONOMY, BUSINESS and FIRST. the customer can select
any one of the options by entering the number that has
been assigned to that travel class option by using
the numeric keypad.
(4.2) Type of Travel.
The customer can select type of travel by pressing on
the corresponding FDK. This row shows travel type i.e.
ONE WAY, ROUND WAY and MULTIPLE STOP OVER. the customer
can select any one of the options by entering the
number that has been assigned to that travel type option.
(4.3) Date of Travel.
On this row user has to enter only the departure date if
the type of travel is ONE WAY by using the numeric
keypad. If the type of travel is ROUND WAY or MULTIPLE
STOP OVER then the user has to enter departure date as
well as arrival date.
(5) Confirmation Page - Display and Edit
This page displays all the data required to make a
booking. This includes the data which was inputted
above as well as data from the profile of the person
making the booking. The user can proceed or edit the
data but choosing the appropriate FDK
(6) Process - Airline Availability Request.
After confirming all the above attributes, the
application will fire a query to host system 20 for
requesting airline availability depending on the
attributes entered above.
(7) Process - Computer Reservation System.
Host system 20 will accept the request from above
process for checking the airline availability on CRS 30.
(8) Output - Display options.
One Way - This page displays options including
FLIGHT SCHEDULE, SEATS AVAILABILITY and FARES for
each and every flight that satisfies the above
conditions. the customer can move on next and
previous page by using FDK 16 if there are more
than eight options displayed on display 14. the
customer can also select the particular option,
which satisfies his/her condition by using the
numeric keypad to input the number corresponding
to the option.
Return Trip and Multiple sector - This page
displays both the sectors. The user can choose
the sector he wants to see by pressing the
appropriate FDK After choosing the sector the
user will get see the options available with
the pricing. If there are more than 8 options
the user can press the appropriate FDK to view
more options. The user can choose a particular
option by using the numeric key to input the
number corresponding to the option. Similarly
he can select options for the other sectors
(9) Input - Select Booking Option.
After selecting the options the user can
choose to BOOK by using the appropriate FDK.
(10) Process - Booking Request.
After selecting Book button, the application
will fire a query to host system 20 for the
booking request i.e. Booking a seat on a
selected airline.
(11) Process - Computer Reservation System.
The host system 20 will accept the request from
above process that the user has sent to the
booking request process to book the seat and
generate PNR number for each and every booking
request.
(12) Input - Select Fare Category For Booking Done.
On this page user has to select the Fare category
for the booking that has been done in the
previous step and the fare category are as
following which user can select by using FDK. The
customer may have to choose from the following
different fares:
NORMAL - (Direct, Flight Specific, Night Fare,
Point to Point
ADVANCE PURCHASE (APEX)
EXCURSION (Return Fare)
(13) Condition - Buy The Ticket.
This page gives the user an option whether to
buy the ticket or not.
(14) If the customer wants to buy the ticket
i.e. (YES) then
(15) Process - Amount Debit Transaction.
This process internally execute the transaction
process that includes host system 20 ACCOUNT
NUMBER, REFERENCE NUMBER which host system 20
generates and the AMOUNT for the airline
ticket which user wants to book.
(16) Process - Bank Switch.
This process i.e. Bank Switch will accept the
above transaction request.
(17) Condition - Balance Availability.
And will check for the balance availability.
If sufficient balance is there in the customers
account i.e. (YES) then
(18) Process - Computer Reservation System.
The application will pass airline ticket number
to CRS 30.
(19) Output - Display Itinerary.
After that CRS 30 will display the itinerary
that includes PNR number, auto generated
transaction ID.
(20) Process - Print Receipt of Itinerary.
After displaying the itinerary this process will
print itinerary.
(21) Condition - Printer Error.
This condition will check if there printer
error or not.
If the Printer Error is there i.e. (YES) Then
(22) Release The PNR No.
Cancel the PNR number
(23) Process - Computer Reservation System.
This process will cancel the PNR number that
has been generated in line number 12.
Go to Line No. 1.
The application will start all over again.
If there is no Printer Error (NO) then
(24) Process - Successful Transaction.
This process will give an indication of successful
transaction and will print a receipt from ATM 12
machine which the user can user for his/her
future reference.
(25) End - Airline Booking System.
If sufficient balance is not there in the customers
account i.e. (NO).
(26) Release The PNR No.
Cancel the PNR number
(27) Process - Computer Reservation System.
This process will cancel the PNR number that has
been generated in line number 12.
Go to Line No. 1.
The application will start all over again.
If the customer does not want to buy the ticket
i.e. (NO)
(28) Release The PNR No.
Cancel the PNR number
(29) Process - Computer Reservation System.
This process will cancel the PNR number that
has been generated in line number 12.
Go to Line No. (1)
The application then starts all over again.

Table 3 is a table listing customer information that can be included in host system database 28.

TABLE 3
FIELD DESCRIPTION

| | |
|---|---|
| LOGIN ID | ASSIGNED BY QUEST2TRAVEL |
| SEQNO | AUTOGENERATED ID FOR |
| | ACCEPTING the RECORD IN |
| | the SAME ORDER AS SEND |
| | FOR BOOKING. |
| TRIPNO | AUTOGENERATED ID FOR |
| | A WHOLE TRIP |
| BOARDING CITY | 3 LETTER CODE OF BOARDING |
| | CITY |
| DESTINATION CITY | 3 LETTER CODE OF |
| | DESTINATION CITY |
| FLIGHT | AIRLINE CODE ALONG WITH |
| | FLIGHT NO |
| BOOKING DATE | DATE FOR BOOKING the |
| | ITINERARY |
| BOOKING FARETYPE | TYPE OF FARE APPLICABLE |
| BOOKING FARES | (CALCULATED BY |
| | QUEST2TRAVEL) |
| | FARE WHICH IS APPLICABLE |
| | FOR THIS ITINERARY. |
| JOURNEY DATE | YYYYMMDD |
| CLASS OF TRAVEL | CLASS OF TRAVEL {ECONOMY/ |
| | BUSINESS/FIRST} |
| BOOKING CLASS | CLASS CODE FOR BOOKING |
| | THIS ITINERARY |
| CONNECTINGFLAG | IS THIS SECTOR |
| | CONNECTING TO |
| | PREVIOUS RECORD |
| SESSIONID | IF ANY SESSION IS |
| | APPLICABLE TO the |
| | REQUEST |
| MEALSERVICE | ANY KIND OF MEAL |
| | PREFERENCE WHILE |
| | BOOKING |

Table 4 is a table listing customer information that can be included in host system database 28.

TABLE 4
FIELD DESCRIPTION

| | |
|---|---|
| TRIPNO | AUTOGENERATED ID |
| | FOR A WHOLE TRIP |
| FLIGHT | AIRLINE CODE ALONG WITH |
| | FLIGHT NO |
| SEQNO | AUTOGENERATED ID |
| | MAINTAINED IN SAME |
| | ORDER AS REQUEST SEND |
| | FOR BOOKING. |
| AIRLINE PNR NUMBER | 6 LETTER AIRLINE PNR |
| | NUMBER |
| GALILEO PNR NUMBER | 6 LETTER GALILEO PNR |
| | NUMBER |
| BOOKING CLASS CODE | SECTOR BOOKED ON WHICH |
| | CLASS CODE |
| BOOKING STATUS | STATUS OF SECTOR BOOKED |
| TIMELIMIT | TIME LIMIT GIVEN TO |
| | RELEASE A BOOKING |
| AIR TICKET NUMBER | AIRLINE TICKET NUMBER |
| | USED FOR BOOKING |

Table 5 is a table of the structure of product provider system database 34.

TABLE 5
PRODUCT PROVIDER SYSTEM DATABASE

| Inputs | Detail | Format | Default |
|---|---|---|---|
| SourceCity | Customer will select | City(Citycode) | Empty |
| | the city by entering | e.g Mumbai(BOM) | |
| | the numeric code from | | |
| | numeric keypad. | | |
| Destination | Customer will select | Cityname(Citycode) | Empty |
| City | the city by entering | e.g Mumbai(BOM) | |
| | the numeric code from | | |
| | numeric keypad. | | |
| Type of | Enter 1 for one way | Alpha-numeric | Empty |
| travel | 2 for round way. | | |
| Date of | Customer will select | DD-MM-YYYY | Empty |
| Travel | the city by entering | | |
| | the numeric code from | | |
| | numeric keypad. | | |
| Class of | Enter 1 for one Business | Alpha-numeric | Empty |
| Travel | 2 for economics | | |

Table 6 is a table illustrating one embodiment of host system database 28.

TABLE 6

| Sr. No. | Field | Format | Description | |
|---|---|---|---|---|
| | SESSIONID | Alpha-Numeric | This is the Session id | Y |
| | | | generated by the system | |
| | BOARDCITY | Character | Source city | Y |
| | OFFCITY | Character | Destination city | Y |
| | JOURNEYDATE | DD-MM-YYYY | Journey date | Y |
| | JOURNEYFLAG | Character | Sector No | Y |
| | ALLFLIGHTS | Character | Any airline preference | Y |
| | TYPEOFJOURNEY | Character | Journey Type i.e. | Y |
| | | | One Way, Round Way | |
| | TIMESPECIFIC | Character | Any Time preference | Y |

| | | | | |
|---|---|---|---|---|
| Sr. No | Field | Format | Description | Mandatory |

Table name: FLIGHTRETRIEVE

| | | | |
|---|---|---|---|
| SESSIONID | Alpha-Numeric | This is the session id | Y |
| | | generated by the system | |
| AIRLINE | Character | Name of Airline | Y |
| FLIGHTNO | Numeric | Flight number. | Y |
| DEPARTDATE | dd-mm-yyyy | Departure date | Y |
| BOARDCODE | Character | Boarding city code | Y |
| BOARDAIRPORT | Character | Boarding airport | Y |
| | | code | |
| OFFCODE | Alpha-Numeric | Destination city code | Y |
| OFFAIRPORT | Character | Destination airport code | Y |
| DEPARTTIME | HH:MI | Time of departure | Y |
| ARRTIME | HH:MI | Time of arrival | Y |
| AIRCRAFTYPE | Character | Type of aircraft | Y |
| FIRST | Character | Seat availability status | Y |
| BUSINESS | Character | Seat availability status | Y |
| ECONOMY | Character | Seat availability status | Y |
| BOOKINGDETAILS | Character | Details of booking in | Y |
| | | various booking code | |
| AIRLINECODE | Character | Airline code | Y |
| JOURNEYFLAG | Character | Journey flag | Y |
| CONNECTINGFLAG | Character | Connecting flag | Y |
| SEQNO | Numeric | Auto generate no | Y |
| CHANGEDATE | dd-mm-yyyy | Arrival date | Y |
| MEALSERVICE | Character | Meal preference | Y |
| STOPCOUNT | Character | No of via points | Y |

Table Name: AIRBOOKTICKETS

| | | | |
|---|---|---|---|
| AUTOINCREMENT | Numeric | Auto increment no. | Y |
| TRIPNO | Numeric | Trip no. | Y |
| BOARDCITY | Character | Boarding city | Y |
| OFFCITY | Character | Destination city | Y |
| FLIGHT | Character | Fight No | Y |
| AIRCRAFT | Character | Aircraft | Y |
| OFFAIRPORT | Character | Airport name | Y |
| BOARDAIRPORT | Character | Boarding airport | Y |
| BOOKINGNUMBER | Alpha-Numeric | Booking number | Y |
| AIRLINE | Character | Airline | Y |
| DEPARTUREDATETIME | HH:MI(24 hr) | Departure time | Y |
| ARRIVALDATETIME | HH:MI(24 hr) | Arrival time | Y |
| BOOKINGDATE | dd-mm-yyyy | Booking date | Y |
| FARES | Numeric | Fares | Y |
| BOOKINGCLASS | Character | Booking class | Y |
| CONNECTFLAG | Character | Connecting flag | Y |
| FAREBREAKUP | Numeric | Fare break up | Y |
| SESSIONID | Alpha-Numeric | Session id generated | Y |
| | | by the system | |
| INSTRUCTIONVIA | Character | Media of Instruction | Y |
| | | received | |
| CLASSOFTRAVEL | Character | Class of travel | Y |
| REFNO | Alpha-Numeric | Booking ref no | Y |
| SMSSEND | Alpha-Numeric | Sms confirmation flag | Y |
| FARETYPE | Alpha-Numeric | Type of fare | Y |
| | abet | | |

Table 7 is a table illustrating one embodiment of financial service system database 38.

Table name: Transaction

| Field name | Format | Detail | Default |
|---|---|---|---|
| order no | Varchar(10) | Reference to | No default |
| | | order info table. | value |
| | | | Unique. |
| Transaction no | Number | This is the 12 | No default |
| | | digit number. | value |
| | | For each trans- | Unique. |
| | | action done by | |
| | | The user the | |
| | | booking host | |
| | | system will auto | |
| | | generate | |
| | | Transaction id | |
| the customerid | Varchar(10) | the customers | No default |
| | | unique id | value |
| Corpid | Varchar(10) | Corporate | No default |
| | | unique id | value |

Table name: Order_info

| Field name | Format | Detail | Default value |
|---|---|---|---|
| order no | Varchar(10) | This is unique id | No default |
| | | for each order | value |
| | | Done by the user | |
| Amount | Number | Amount of | Null |
| | | transaction | |
| Order status | Varchar(1) | Processing or | Pending(p) |
| | | pending | |
| Date_of_order | Date | Date of order | Sysdate |
| | (DD-MM-YYYY) | generated | |
| Item | Varchar | Airline ticket, | No default |
| | | hotel, car | value |
| Ref_no | Number | Reference number | No default |
| | | create by the host | value |
| | | booking system | |
| Transaction | Number | | No default |
| no | | | value |

Table name: Transaction_info

| Field Name | Format | Description | Default |
|---|---|---|---|
| transaction no | Number | This is the 12 digit | No defaul |
| | | number. For each | t value |
| | | transaction done | |
| | | by The user the | |
| | | booking host system | |
| | | will auto generated | |
| | | Transaction id | |
| amount | Number | Amount of | NULL |
| | | transaction | |
| card_no | Number | the customers bank | No default |
| | | card no | value |
| finacer_name | Varchar | Bank name or Any | No default |
| | | other financer name | value |
| transactiontype | varchar | Debit card trans- | No default |
| (debit/credit) | | action or credit | value |
| | | card transaction | |
| cardtype | varchar | Visa or master card | No default |
| (Visa/Master) | | type | value |
| exp_date | Date | Expiry date of Card | No default |
| | | | value |
| name_oncard | varchar | Name of user on card | No default |
| | | | value |
| Currency | Number | Currency of | No default |
| | | transaction | value |
| order_no | varchar | Reference to the | No default |
| | | order_info table | value |
| exponentvalues | Number | Max number of digit. | 2 |

In another embodiment of the present invention, illustrated in FIG. 13, an ATM device 110 is provided for booking a purchase of a product or service through an ATM 112 that includes a display 114 and FDK's 116. A computer program 118 is included that, implements a gathering of selected booking information in response to the booking query by a customer, implements selection of a booking from the displayed gathered booking information by the customer at the ATM interface, and implements receipt of a confirmation of selected gathered booking information at the ATM interface.

Referring again to FIGS. 4 and 5, in another embodiment of the present invention, a computer readable medium 210 is provided which has stored thereon instructions which, when executed by a processor 212, cause processor 212 to perform, executing a first application 214 including gathering selected booking information in response to the booking query and displaying gathered booking information at an ATM interface 216. A second application 218 executes selection of a booking from the displayed gathered booking information by the customer at ATM interface 216, and executes a third application 220 including receiving a confirmation of selected gathered booking information at ATM interface 222.

To check for availability and booking the request goes from ATM 12 to a server 36. A CGI program of host system 20 on the server 36 routes the request with the required parameters to host server 36. The request can uses the database 28 as an intermediate to interact with host system 20 and server 36. The CGI program on host server can interface with CRS 30 using either OLE or XML. The host program can choose one of the following processes to get response from CRS 30 and host server and server 36. This can be done in Visual Basic, VJ++, VC++, Javascript, VBScript, Jscript and Perl using COM architecture. It can also be done in DCOM, J2EE (Java based) architecture, and the like.

When using OLE select, the program can be written in Visual Basic. This program can be written in any of the application in Visual Studio including but not limited to VJ++, VC++, and the like. The code starts by first creating the instance of the OLE Object which provides the functionality to request CRS 30. Using OLE object a query is sent to CRS 30 for obtaining seat availability. A filter is used that allows host system 20 to only select useful data from the response. The fields that are needed are specified. There are some data element reference operators which can be attached to the filters for e.g. BoardCity|X25—decodes the Board City and Gives the Airport Codes. For instance “BOM”when decoded with X25 can be formatted to “Bombay Airport,,IN”JoumeyTime|FT2—gives the time in [24-hour clock] like 13:00.

Using such filters the Response is filtered accordingly, and the selected columns are retrieved.

When using XML the program selected can be written in Perl. This program is written in Perl and can be written in any of the application in JavaScript, VBScript, Jscript and Visual Studio such as VJ++, VC++, and the like. The code starts by first creating the instance of the XML Object which provides the functionality to request CRS 30. Using XML object a query is sent to CRS 30 for obtaining seat availability. A filter is used which allow the host system to only select useful data from the response.

In another embodiment of the present invention, the methods and systems of the present invention permit customers to purchase lottery, or other gaming tickets through an ATM 12 or other device listed above. With the methods and systems of the present invention, customers can play any state lottery from any location. The money for the transaction can be directly debited to the customer's account and the receipt generated will proof of purchase. A record of the transaction is produced, and additional copies of this receipt can be printed at any time. Lottery winnings can be directly credited to the customer's account. Based on the time lapsed and the corresponding lottery's rules, cancellations are permitted.

With the methods and systems of the present invention, customers can supervise their gaming activity on their own through periodic account statements that present all participation charges and winning credits. Because the entire process is database driven customers are able to access records of their past participations with all information regarding their previous bets. Each and every transaction/participation charges or winning transfers can be identified and is traceable. With the present invention, a customer can select a series of of numbers that can be played time and again for different draws and lotteries.

By entering their wager through an ATM 12, customers will by entering can ensure their participation automatically to the desired lottery. Each display 14 displayed to the customer for a desired lottery can be adapted to the specific lottery rules. In response to the application rules and regulations of a lottery, customers can be provided with options to choose between a one time upfront payout and annuity payment options.

The following are some of the terms can be used in offering lottery purchases through an ATM 12 with the present invention.

Active means that the specific lottery drawing is still open for participation.

Closed means that the specific draw is currently closed for new bets, drawing results have not yet been updated and your bet has not yet been checked for winnings.

Processing means that the draw results are currently being entered to the system and the lottery entries are being checked for winnings.

No Win means that this lottery entry was checked according to the lottery results and no winnings were found.

Account Refusal means funds in the customer's account were insufficient to make the purchase causing participation to be deleted. This entry will not enter the draw and no charges are made to the customer's account.

Cancelled means that this transaction was cancelled upon the customer's request for whatever reason. No charges are made.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

### APPENDIX A

This appendix A represents the source code that allows customers to navigate on the ATM machines using the FDK keys to make their choices.

Program:

Variables Needed to Highlight the Field on Click of FDK

| | |
|---|---|
| var HightlightColor=″#DBEAF5″; | var NormalColor=″#FFFFFF″;var ObjField=Pattern=″; |
| var currPos = divTotalTxt = 0; | var divName = divCurrent = ″; |

Function to Highlight the Field on Click of FDK
The following function is written in Javascript. It can also be written in VBScript, JScript
function highlightMenu(Name, Current, ObjFld, Patt, TotalTxt) {

errorMessage(″″);
if(divName!=″){

//deHighlight Color
if(divTotalTxt!=0) document.all[divName +

divCurrent].style.backgroundColor=NormalColor;

if(divTotalTxt > 1) {

for (var j=0; j<divTotalTxt; j++)

document.all[divName + divCurrent +

″0″][j].style.backgroundColor=NormalColor;

| } | |
|---|---|
| else if(divTotalTxt==1) | document.all[divName + divCurrent + |

″0″].style.backgroundColor=NormalColor;

}
//Highlight Color
if(TotalTxt!=0) document.all[Name+Current].style.backgroundColor=HightlightColor;
if(TotalTxt > 1){

for (var j=0; j<TotalTxt; j++)

document.all[Name + Current +

″0″][j].style.backgroundColor=HightlightColor;

}
else if(TotalTxt==1) document.all[Name + Current +

″0″].style.backgroundColor=HightlightColor;

| ObjField = ObjFld; | |
|---|---|
| Pattern = Patt; | |
| var Idx = ObjField.value.indexOf(′ ′); | |
| currPos = ((Idx>−1) ? Idx : 0); | |
| if(Patt instanceof Array==false && ObjField.value.length!=Pattern.length) | |
| ObjField.value = Patt.replace(/X/g,′ ′); | |
| divName = Name; | divCurrent = Current; divTotalTxt=TotalTxt; |

}
Function for Setting Value in the Activated Field on Pressing the Numeric Keys
The following function is written in Javascript. It can also be written in VBScript, JScript
function setVal(val) {

//alert(divName + ″\t″ + ObjField.value.length + ″\t″ + Pattern.length);
errorMessage(″″);
if(divName!=″){

if(Pattern instanceof Array) {

if(val>0 && val <= Pattern.length) ObjField.value = Pattern[val−1];
else {

errorMessage(″Invalid Key Pressed. Choose your options from

buttons [1−″

+ Pattern.length + ″]″);

ObjField.value = ″″;

}

}
else {

var TmpPatt = Pattern.replace(/X/g,′ ′);
if (ObjField.value==TmpPatt ∥ currPos==Pattern.length) currPos=0;
//alert(ObjField.value.length + ″\t″ + Pattern.length);
if(ObjField.value.length != Pattern.length) {

| //alert(″if ″ + Pattern.length); | |
|---|---|
| ObjField.value += val; | |
| var idx = Pattern.indexOf(″-″, ObjField.value.length); | |
| if(idx == ObjField.value.length) | ObjField.value += ″-″; |

| } | |
|---|---|
| else if(currPos<Pattern.length) | { |

| //alert(″else ″ + Pattern.length); | |
|---|---|
| var idx = Pattern.indexOf(″-″, currPos); | |
| if(idx == currPos) | currPos++; |

ObjField.value = ObjField.value.substr(0, currPos) + val

+ ObjField.value.substr(currPos+1,

ObjField.value.length);

currPos = ((Pattern.length == currPos) ? 0 : currPos+1);

}

}

}
else {

errorMessage(″Note: Press the side buttons to highlight the field you want to

write into !″);

}

}
Function for Clearing the Value from the Activated Field on Pressing the “CLEAR” Key
The following function is written in Javascript. It can also be written in VBScript, JScript
function clearVal( ) {

if(divName!=″){

if(Pattern instanceof Array == false) {

| if (Pattern==′XX′) | ObjField.value=″; |
|---|---|
| var idxChar = ObjField.value.substr(currPos−1,1); | |
| if(idxChar == ′-′) | currPos--; |

if(currPos!=0) ObjField.value = ObjField.value.substr(0, currPos−1) + ′ ′

+ ObjField.value.substr(currPos,

ObjField.value.length);

currPos = ((currPos==0) ? Pattern.length : currPos−1);

}

}
else {

errorMessage(″Note: Press the side buttons to highlight the field you want to

write into !″);

}

}

1. A method of booking, comprising:
entering at least one booking query at an ATM interface by a customer;
gathering selected booking information in response to the booking query and displaying gathered booking information at ATM 12 interface;
selecting a booking from the displayed gathered booking information by the customer at ATM 12 interface; and
receiving a confirmation of selected gathered booking information at ATM 12 interface.

2. The method of claim 1, wherein ATM includes a display screen and function display keys.

3. The method of claim 1, further comprising:
registering the customer with a host.

4. The method of claim 1, wherein the host gathers the selected booking information.

5. The method of claim 4, further comprising:
directing the gathered booking information by the host to ATM.

6. The method of claim 3, wherein the customer completes a customer profile upon registration with the host.

7. The method of claim 3, wherein the booking as an airline ticket booking.

8. The method of claim 3, wherein the booking is selected from at least one of, stocks, fixed deposit investments, gaming, a musical event, sporting event and a theatrical production.

9. The method of claim 7, further comprising:
displaying a list of departure cities by the host at ATM 12 in response to a request by the customer to book an airline ticket.

10. The method of claim 9, further comprising:
selecting by the customer at ATM a city a departure city from the list of departure cities.

11. The method of claim 9, further comprising:
displaying a list of destination cities by the host at the ATM.

12. The method of claim 9, further comprising:
selecting a class of travel by the customer at the ATM.

13. The method of claim 9, further comprising:
selecting a type of travel by the customer at the ATM defined as one way, round way and multiple stop over.

14. The method of claim 9, further comprising:
displaying an itinerary by the host of the airline ticket booking at the ATM.

15. The method of claim 14, wherein the itinerary is editable by the customer.

16. The method of claim 14, further comprising:
checking availability of the itinerary of the airline booking by the host.

17. The method of claim 16, further comprising:
displaying availability of the itinerary of the airline booking by the host at the ATM.

18. The method of claim 17., further comprising:
booking the itinerary of the airline booking by the customer at the ATM.

19. The method of claim 18, further comprising:
entering a method of payment for the itinerary of the airline booking by the customer at the ATM.

20. The method of claim 1, wherein entered selected booking information airline travel information is selected from at least one of, a departure city, a destination city, and a class of travel.

21. The method of claim 1, wherein the gathered booking information includes airline travel information selected at least one of, a departure city from a list of departure cities, a destination city from a list of destination cities, class of travel, and a fare.

22. The method of claim 1, further comprising:
formatting the at least one booking query by the host system as a string of commands that the provider system can interact with;
creating a first response to the booking query by the provider system;
sorting the first response by the host system to create the gather information; and
providing the gathered booking information to the ATM for review by the customer.

23. The method of claim 1, wherein receiving a confirmation of selected gathered booking information is provides a confirmation between an airline and a customer.

24. The method of claim 1, wherein the booking selected is an airline booking.

25. The method of claim 1, wherein the booking selected is selected from at least one of, travel arrangements, airline tickets, purchase and/or sale of stocks and other equities, purchase and sale of fixed deposit investments, gaming, musical events, sporting events, theatrical productions and media subscriptions.

26. The method of claim 1, wherein the gathered booking information includes a plurality of airline flight schedules and a plurality of airline fares.

27. The method of claim 1, further comprising:
entering a customer identifier at the ATM prior to entering the desired booking information.

28. The method of claim 1, wherein the booking is a book and hold.

29. The method of claim 1, wherein the booking is a book and issue. providing a help line to assist in bookings.

30. The method of claim 1, further comprising:
debiting an account of the customer for purchased bookings.

31. The method of claim 30, further comprising:
reversing debiting of the account if the purchased bookings are cancelled within a guideline.

32. The method of claim 30, wherein the account of the customer is selected from at least one of a checking account, savings account and a credit card account.

33. The method of claim 1, wherein selecting the booking creates a transaction between the customer and a booking provider.

34. The method of claim 33, further comprising:
reversing the booking.

35. The method of claim 1, wherein the confirmation of selected gathered booking information includes a travel itinerary.

36. The method of claim 1, wherein the confirmation of selected gathered booking information includes an option to purchase or cancel.

37. The method of claim 1, further comprising:
selecting by the customer a financial institution for payment of purchased bookings.

38. A system for booking, comprising:
an ATM interface;
a host system coupled to the ATM interface;
a product provider system coupled to the host system, wherein in response to a booking query received by the host system from a customer, the host system queries the product provider system, and the product provider system provides responses to the host system relative to the queries.; and
a financial service system coupled to the host system.

39. The system of claim 38, wherein the product system includes at least one product provider system server and at least one product provider system database, and the host system includes at least one host system server and at least one host system database.

40. The system of claim 39, wherein the product provider system database includes listings of at least one of, airline boarding cities, airline destination cities, airlines, flight numbers, times of airline departures and airline fares.

41. The system of claim 39, wherein the host system database includes received customer information and access codes to the product provider system database.

42. The system of claim 39, wherein the host system database includes customer profiles.

43. The system of claim 39, wherein in response to a customer selecting booking information the host system is configured to provide availability and booking information.

44. The system of claim 39, wherein the host system is configured to,
receive a booking request from a customer, send at least a portion of the request to a centralized reservation system, receives data relative to the booking request from the centralized reservation system, and filter at least a portion of the data received from the centralized reservation system.

45. The system of claim 39, wherein the host system database includes information about airlines flight schedules, airline flight routes, airline flight departure and arrival times, and fares.

46. The system of claim 39, wherein in response to a customer booking query, host system is configured to route the query to a reservations server.

47. The system of claim 46, wherein host system sorts data that is polled in response to the query and produces a booking output.

48. The system of claim 47, wherein host system attaches fares with the booking output.

49. The system of claim 38, wherein the host system and product provider system communication several times in response to a booking query received by the host system from a customer.

50. The system of claim 38, wherein the financial service system includes at least one financial service system server and at least one financial service system database.

51. The system of claim 50, wherein the financial service system database includes financial information about a customer including customer name, customer account number, customer access code, and a balance of a customer account.

52. The system of claim 51, wherein the financial service system database includes financial information including a balance of a host system account.

53. A computer based system that enables a customer to executes a booking for a product or service at an ATM, comprising:
a first processor that receives a query from a customer at the ATM for booking information relative to a product or service;
a second processor coupled to the first processor and to the ATM, the second processor configured to provide a first booking information to the first processor in response to a request made by the second processor to the first processor, the first processor producing a second booking information in response to receipt of the first booking information and forwarding the second booking information to the customer at the ATM; and
a third processor coupled to the second processor, the third processor configured to assist in providing financial settlement on behalf of the customer for a purchase made by the customer of a booking, where the purchase of the booking is in response to second booking information.

54. The system of claim 53, wherein the first processor is a product provider system processor that includes a database of booking information for at least one product or service.

55. The system of claim 54, wherein the second processor is a host system processor.

56. The system of claim 55, wherein the third processor is a financial services system processor.

57. The system of claim 54, wherein the product provider system database includes listings of airline boarding cities, airline destination cities, airlines, flight numbers, times of airline departures and airline fares.

58. The system of claim 53, wherein the first booking information and the second booking in formation are the same.

59. The system of claim 53, wherein the first information is received from centralized reservation system and the second information is information that the host system receives from the centralized filtering the information and then filters the information.

60. The system of claim 53, wherein the first booking information and the second booking information are different.

61. The system of claim 53, wherein the second booking information includes information from the first booking information.

62. A method for booking a purchase of a product or service to an ATM comprising:
entering at least one booking query at an ATM interface by customer:
implementing a gathering of selected booking information in response to the booking query:
implementing selection of booking from the displayed gathered booking information by the customer at the ATM interface:
implementing receipt of a confirmation of selected gathered booking information at the ATM interface:

63. The method of claim 62, further comprising:
implementing registration of the customer with a host.

64. The method of claim 63 further comprising:
implementing the steps of directing the gathered booking information by the host to the ATM.

65. The method of claim 62 further comprising:
implementing a method of payment for a purchased product or service through the ATM

66. An ATM device for booking a purchase of a product or service through an ATM, comprising:
a display;
an ATM interface coupled to the display;
function display keys coupled to the ATM interface; and
a computer program that implements a gathering of selected booking information in response to the booking query by a customer;
implements selection of a booking from the displayed gathered booking information by the customer at the ATM interface; and
implements receipt of a confirmation of selected gathered booking information at the ATM interface.

67. A computer readable medium having stored thereon instructions which, when executed by a processor, causes the processor to perform:
executing a first application including gathering selected booking information in response to the booking query and displaying gathered booking information at the ATM interface;
executing a second application including selecting a booking from the displayed gathered booking information by the customer at the ATM interface; and
executing a third application including receiving a confirmation of selected gathered booking information at the ATM interface.

68. A computer based system that implements bookings in response to a booking query made at an ATM interface by a customer, comprising:
a first processor that produces selected booking information in response to the booking query made by a customer at an ATM; and
a second processor that selects a booking from the displayed gathered booking information by the customer at the ATM interface, wherein a confirmation of selected gathered booking information is received at the ATM interface.
